(19) United States
(12) Patent Application Publication
(10) Pub. No.: US 2014/0089020 A1
(43) Pub. Date: Mar. 27, 2014

(54) SYSTEMS AND METHODS FOR OPTIMIZING MARKETS FOR TEMPORARY LIVING SPACE

(71) Applicant: Suitest IP Group, Inc., Oak Park, CA (US)

(72) Inventor: Jeremy M. Murphy, Oak Park, CA (US)

(73) Assignee: Suitest IP Group, Inc., Oak Park, CA (US)

(21) Appl. No.: 14/040,555

(22) Filed: Sep. 27, 2013

Related U.S. Application Data
(60) Provisional application No. 61/706,213, filed on Sep. 27, 2012.
(60) Provisional application No. 61/752,455, filed on Jan. 15, 2013.

(51) Int. Cl. G06Q 10/02

(52) U.S. Cl. CPC G06Q 10/02
USPC 705/5

(57) ABSTRACT

A computer implemented method of allocating costs of a rentable unit across two or more users includes the steps of: assigning two or more users to an event; assigning a date range to the event; assigning a rentable unit to the event, wherein the rentable unit includes two or more heterogeneous sleeping areas and a total price for the assigned date range; assigning a sleeping area to each of the users; and allocating a sub-total to each of the users based on relative value of the assigned heterogeneous sleeping area, wherein the sum of the allocated sub-totals equals the total price of the rentable unit for the assigned date range.

### CROSS-REFERENCE TO RELATED APPLICATIONS

This application incorporates by reference and claims priority to U.S. Provisional Application No. 61/706,213, filed on Sep. 27, 2012, and U.S. Provisional Application No. 61/752,455, filed on Jan. 15, 2013.

### BACKGROUND OF THE INVENTION

The present subject matter relates generally to a system for optimizing markets for temporary living space. More specifically, the present invention relates to a system of travel research, booking, and management that combines a method of purchasing and occupying a rentable unit of living space by more than one traveler; a travel meta-search engine and hotel data distribution system; a method for discovering, evaluating, purchasing and occupying a rentable unit of living space; and a price analysis system.

Hotel search engines are commonly used when planning and booking travel. However, previously existing systems had limitations that prevented users from optimal access to relevant information, resources, and functions. For example, while prior systems enabled users to search pricing and locational data, they were unable to effectively consider and compare room amenities like TV size, Wi-Fi price, room size, etc. For example, while this information was sometimes accessible through various sources, such as the hotel's website, there was not a consolidated system that enabled effective searches and comparisons.

Additionally, users did not previously have a system that enabled qualitative real-time analysis of the value of a given hotel room. While various guides and reports may provide some indication of which hotels may have the best deals, there were not systems that enable variable real-time grading of the quality of the deal offered on a given hotel room based on historical and present comparative data analysis.

Accordingly, there is a need for an improved hotel search engine system as described and claimed herein.

### BRIEF SUMMARY OF THE INVENTION

The present subject matter relates generally to a system for optimizing markets for temporary living space. More specifically, the present invention relates to a system of travel research, booking and management that combines a method of purchasing and occupying a rentable unit of living space by more than one traveler; a travel meta-search engine and hotel data distribution system; a method for discovering, evaluating, purchasing and occupying a rentable unit of living space; and a price analysis system. The subsystems taught herein, and each of their individual components, are meant to integrate with each other, over networks or as part of a stand-alone software platform, to create an integrated software system that empowers, enables, and creates efficiencies for hoteliers, travel agents, and travelers.

While the primary embodiments described herein are directed towards travelers sharing a rentable unit in a hotel, hotel meta-search and hotel room distribution systems, travelers occupying a rentable unit in a hotel, hotel search and distribution, and price analysis in online hotel search, there are numerous applications in which the subject matter presented will be valuable. For instance, the method of purchasing and occupying a rentable living space by more than one traveler may be applied to the division of a house or flat among multiple travelers or tenants, as several of the advantages provided to travelers and hoteliers through the system described herein apply to tenants and property managers as well. Furthermore, the modified auction system described in this method could be adapted to virtually any context in which a good, service or asset with an exogenously determined market value is composed of sub-assets that are sold or leased individually at separate prices that must sum to the exogenously determined total price. Or, for example, the travel meta-search engine and hotel data distribution system described herein may be applied to individual rooms or other rentable units, or more generally to comparison-shopping for various consumer products and services. In another example, the method for discovering, evaluating, purchasing and occupying a rentable unit of living space may be applied to the evaluation of homes offered for monthly, weekly or nightly lease, as several of the advantages provided to travelers and hoteliers through the system described herein apply to tenants, homeowners and property managers. Finally, the price analysis system herein described may be applied to home/apartment rentals, event tickets, or even consumer products. It will be apparent that the solutions provided herein may be applied in numerous additional contexts.

The system greatly improves the optimization of scarce resources for all interested parties. The system's efficiencies enable the profitable use of assets that would otherwise be uneconomical and utilized sub-optimally by improving the efficiency of the market for hotel rooms, and directing traveler demand to the supply of rentable units that best satisfy objectives and optimize traveler utility.

First, travelers are empowered to split hotel accommodations with other travelers. In many cases, each traveler could not afford the accommodations or could not fully enjoy the accommodations without the participation of other travelers. The system's efficiencies reduce the time that travelers splitting hotel accommodations spend planning and bargaining amongst each other, reduce the risk and monitoring costs associated with a traveler not paying his/her share of the price, and reduce the risk that a hotel accommodation will fail to satisfy the travelers' needs. From the perspective of hoteliers and travel agents, the system introduces a viable means of marketing and selling a single rentable unit to multiple consumers who individually could not afford the unit. As context, luxury suites in hotels tend to be many times larger and many times more expensive to rent than standard rooms. For that reason, these suites typically attract only a narrow segment of the market. This poses a dilemma for hoteliers: such suites are vital to enhancing the prestige of the hotel, but often go unoccupied because demand for such suites from individual travelers is small and inconsistent. By enabling multiple travelers to split luxury suites efficiently, the system introduces new demand and thereby increases asset utilization by hotel operators and travel agents.

Second, travelers are able to reduce search costs associated with finding and evaluating hotel rooms. Travelers are enabled to specify the utility they derive from attributes associated with rentable units and are empowered by computer processing to discover which rentable units offer them the greatest total utility, or the greatest utility per dollar, or the greatest utility within a budget. In many cases, a traveler could not reach such a determination without the aid of the system because the relevant data points are too numerous and too difficult to compare, and the number of rentable units is too great or the number of characteristics of rentable units is too great. The system's efficiencies are able to significantly reduce the time and labor that travelers spend searching for and evaluating rentable units and reduces the risk that a rentable unit will fail to satisfy travelers' needs.

Hoteliers and travel agents will benefit from enhanced ability to monitor compliance with best-available-rate guarantees and from reduced “look-to-book” ratios due to more efficient search, which naturally reduces the overhead costs of data distribution systems. The system reduces “look-to-book” ratios by reducing the number of queries consumers must execute to find an acceptable unit of rentable space. The system also enables hoteliers and travel agents to determine market-clearing (or revenue optimizing, or profit optimizing) prices for rentable units.

The system looks at all aspects of the hotel search and booking process, and addresses the inefficiencies in the existing art. The division of a rentable unit in a hotel by multiple travelers has long been practiced. Oftentimes, friends and colleagues find it more cost effective or more enjoyable to occupy a single rentable unit and split the price, rather than renting separate units from the hotelier. Splitting accommodations has been limited, however, by its attendant costs and frictions. Foremost among these frictions is negotiating a fair allocation of price and sleeping arrangements. It should be noted that although the focus of the below discussions and descriptions is on the allocation of beds, the discussions and descriptions apply equally to any other feature of a shared accommodation, especially non-communal features of the accommodation. Beds are frequently mentioned herein to offer a salient example, not to limit the application of the system.

Other goods and assets that are commonly split among friends are less thorny because they are essentially homogeneous: tickets to sporting events, for example, are virtually identical within a given section and row of an arena where a cluster of friends might sit together. In contrast, a rentable unit in a hotel can seldom be divided into homogeneous subunits. Rather, travelers splitting hotel accommodations typically encounter situations like the following: one person will be sleeping on a pull-out couch in the living room, one person will be sleeping on a queen bed in a small second bedroom, and two people will be sleeping together on a king bed in the master bedroom. It is not in general regarded as equitable for someone sleeping on a couch in the living room to pay the same amount as someone sleeping on a king bed in a master bedroom. Moreover, assigning individuals to beds in the first place is no trivial matter either. Social relationships generally constrain which people should sleep in the same bed or even in the same room, and hotel rules often constrain the total number of guests permitted to sleep in a given rentable unit. Making matters more complex still, the bedding situation in a particular rentable unit of a hotel is often variable, allowing for the substitution of a king bed with two double beds or the addition of a rollaway bed, for instance.

Adding to this sea of troubles, travelers usually lack information about the layout of rooms and beds prior to arriving at their hotel, which instigates a mad dash to claim beds and bedrooms upon arrival. If a traveler successfully obtains information about bedding layouts prior to arrival (such as through a hotel website), sharing that information with others and negotiating the assignment of travelers to beds typically necessitates multiple rounds of cantankerous interaction.

The perceived unfairness of the allocation of price and beds among travelers is closely tied to a second problem: monitoring and collecting payments. Travelers are less likely to pay their allocated share of the collective price if they feel that the price allocation process is unfair, and even if all travelers feel that the price allocation process is fair, some of them still might not pay. Furthermore, unlike other assets that are commonly split among friends and colleagues, hotel stays are frequently accompanied by incidental charges that accrue subsequent to the basic charge. Thus, monitoring and collection is a necessary, ongoing and potentially irksome process for travelers splitting hotel accommodations. Travelers typically employ crude techniques to monitor and collect payment of the aggregate purchase price. These techniques include tracking payments on spreadsheets, manually sending email reminders to delinquent travelers, and meeting in person to exchange cash or checks.

For travelers attempting to negotiate payment prior to booking, an additional wrinkle arises. Prices of hotel rooms vary from minute to minute based on revenue-optimization formulas employed by hoteliers in response to stochastic demand. As such, travelers attempting to negotiate and collect payment for a shared hotel accommodation that has not yet been booked must continually re-negotiate the price that is to be paid by each traveler. This could potentially lead to hundreds of interactions and attempted collections prior to booking.

Hoteliers and travel agents face problems that mirror those facing travelers. If travelers splitting hotel accommodations are stymied by their inability to negotiate a fair allocation of beds and prices, or are stymied by their inability to collect payment, they will probably cancel their reservation or not make reservations in the first place, which leaves hotel assets underutilized. Furthermore, the inability of hoteliers and travel agencies to systematically and fairly divide a rentable unit into subunits based on bedding layouts forecloses marketing opportunities. Without an accurate and efficient means of showing friends in a social network the savings each could achieve by booking a single accommodation together, and without a means of receiving payment from a collection of such travelers, hoteliers and travel agencies have no way to cultivate this source of demand for large suites.

Booking a hotel room is a difficult process even if the travelers are not splitting it among several people. Travelers searching for hotel rooms may find the task time-consuming, laborious, and unpleasant. When searching for hotel rooms, travelers typically visit multiple inventory sources (for example, expedia.com, priceline.com, traditional travel agencies and distribution systems) and dozens of websites over a period of weeks in hopes of finding the best deal and the most value for their money. The potentially relevant factors include the characteristics of the property as a whole, the characteristics of the specific rentable unit, the dates of travel, the city, the neighborhood, the preferences of the traveler, and the prices—including fees and discounts—of nearly every room everywhere. Such information is generally scattered across numerous webpages on numerous websites, and even if a traveler had time to find all relevant information, analyzing it would be an overwhelming challenge.

Existing meta-search engines have partially alleviated this problem by aggregating sources of inventory for each hotel. Inventory sources are typically online travel agencies, global distribution systems, central reservation systems and the like. Aggregating availability and rates applicable to a hotel from these inventory sources is not particularly difficult because each hotel possesses unique identifiers such as street address, latitude and longitude. As such, when aggregating availability and rates applicable to a hotel, meta-search engines can generally identify a hotel by matching (i) the address or latitude and longitude associated with the hotel in a database with (ii) the address or latitude and longitude received from an inventory source. Once hotels have been mapped to data received from each inventory source, the meta-search engine can aggregate for each hotel the prices and availability received from multiple data sources.

The methods currently practiced by meta-search engines, however, fail to solve the entire problem faced by comparison shoppers. Specifically, meta-search engines fail to aggregate prices by room-class within a hotel because, until now, there has been no known system for associating consistent room-classes with prices and availability received from multiple inventory sources. Unlike airline tickets (which are basically homogeneous along a given route at a given time) and unlike event tickets (which are uniquely defined by a row value and section value), rentable units are overflowing with characteristics (quantitative and qualitative, objective and subjective) without any standardized language to facilitate comparison and analysis. Consequently, meta-search engines generally only facilitate comparison-shopping with respect to the lowest overall price listing at a hotel from each inventory source. Using current meta-search engine technology, travelers seeking to find the lowest rate on a Junior Suite at Hotel X cannot efficiently compare prices across multiple inventory sources because the meta-search engine simply does not know which prices received from Inventory Source R, Inventory Source S, and Inventory Source T pertain to the Junior Suite at Hotel X; the meta-search engine merely knows that it received some prices, room names, room codes and other information applicable to Hotel X from each inventory source.

Matching room-classes of a hotel across multiple inventory sources is extremely difficult because (i) the room-class prices received from different inventory sources are often different, hence the need for comparison-shopping in the first place; (ii) the room-class names received from different inventory sources are often different; and (iii) the room-class numeric codes received from different inventory sources are different, as they are created separately by each inventory source, or there may be no room-class numeric codes, such as when the price and availability information are obtained by the methods known in the art as “crawling” and “screen scraping.” Unlike other items of inventory that are aggregated from multiple sources (such as event tickets, which each have a unique row and section), hotel room-classes often have wildly inconsistent identifiers across inventory sources. When identifying a single room-class within a given hotel, one inventory source may use the name “Junior Suite,” while another uses the name “Jr Suite” and yet another uses the name “1 King Bd Ste 1 Room.” Inventory sources typically also provide descriptive information about the amenities associated with a room-class, usually in a string of text. These descriptions generally suffer from the same inconsistency across inventory sources as room-class names. For instance, in describing a suite that has a jetted tub, one inventory source may include the text “Jacuzzi” while a second inventory source includes the text “upgraded tub” and a third includes the text “spa bathroom.” Thus, a crucial step in evaluating rentable units is interpreting and standardizing qualitative data received from data sources to facilitate quantitative analysis. Additionally, even with respect to data that is standardized or quantitative by nature, current systems fail to utilize such data in an efficient or effective manner. Sometimes, whether room-classes from different inventory sources actually match cannot be known with certainty but only within a range of probability. Complicating matters further, room names and descriptions change from time to time as hoteliers renovate rooms or modify the classification of rooms. Thus, matching room-classes across inventory sources requires nuanced and continual analysis.

Currently, comparison shoppers are saddled with the burden of sorting through numerous prices and room descriptions to match room-classes of a hotel across multiple inventory sources. Not only is this time-consuming and inefficient, but travelers lack the analytical tools necessary to systematically assess which listings from multiple inventory sources are the most likely room-class matches. As a result, comparison-shopping within room-classes is rendered virtually impossible.

Furthermore, without the ability to associate price-listings from various inventory sources with defined room-classes, search engines cannot implement deal identification that involves statistical analysis of the prices and attributes of room-classes, since there is no way to even determine which price listings pertain to a known room-class whose attributes have been stored by the deal system.

Hoteliers, travel agents and other sellers of travel face similar problems when setting prices for rentable units. Revenue management systems attempt to derive optimal prices from forecasts and historical data relating to supply, demand and competition. A major shortcoming of revenue management systems is the inability to precisely quantify the position of each rentable unit in the competitive landscape, which is necessary to determine the optimal offer price of those units. Currently, characterizations of rentable units are not precise enough to facilitate true revenue optimization.

Furthermore, without the ability to associate price-listings from various inventory sources with defined room-classes, hoteliers and others cannot efficiently monitor the pricing policies written in distribution contracts. Because price competition in the hotel industry is fierce, contracts between hoteliers and travel sellers often stipulate price floors and other policies intended to optimize the revenue of all parties involved. Violations of such policies reduce the revenues of the hotelier and undermine the credibility of the pricing structure. Currently, hoteliers and others have limited ability to monitor the prices at which travel sellers offer room-classes, since there is no efficient means of associating prices listed on the websites of travel sellers with defined room-classes.

Similar problems exist for travelers, meta-search engines and others attempting to associate media, reviews, comments and the like with particular hotels, room-types or rentable units. For instance, a traveler searching for a “Junior Suite” at Hotel X may be interested in viewing YouTube videos, Tweets or other social media related to that room-type. Unfortunately, without a system for efficiently associating room-classes with various pieces of media, reviews and the like, the traveler is burdened with the task of searching multiple media and social media outlets and manually comparing results.

When it comes to allowing travelers to weigh their accommodation priorities, existing hotel search engines are as inadequate as they are inconsistent. Different travelers have different sets of preferences. Accordingly, the perceived value of an attribute of a rentable unit will vary from traveler to traveler. Existing travel websites allow travelers to filter or rank rentable units by matching binary indications of the traveler's preference for certain attributes with binary tables indicating the existence or non-existence of an attribute with respect to a particular rentable unit. For instance, in the existing art, a traveler is often presented with a list of hotel attributes and checkboxes; the traveler marks the checkboxes as binary indications of his preference for selected attributes, and the website returns those hotels for which selected attributes are found to exist in database tables. There are several problems with that method. First, a traveler is likely to desire different attributes with different intensities. For instance, a traveler may desire that a property have a pool and a gym, but he may want the pool much more than the gym. If the traveler were forced to make a binary indication of his preferences, he would be forced to choose between ignoring the gym attribute or elevating it to the same status as the pool attribute. Neither choice expresses the traveler's actual preferences. Second, attributes of rentable units can seldom be sufficiently described in binary terms (as simply existing or not existing). For example, a hotel pool could be shallow and poorly maintained, or it could be extravagant and lively. Travelers who have a strong preference for the pool attribute are likely to derive more utility from a lavish pool than a shabby one; merely ranking hotels according to whether the hotel has a pool is therefore not sufficient. Third, a traveler may desire an attribute, but not at any price: a traveler may be willing to pay an extra $20 to stay at a property with a pool, but not an extra $50. Thus, simply indicating a binary preference for a pool is not sufficient in determining whether a property with a pool is more desirable than a property without a pool when the two properties are offered at different prices. As a result of these shortcomings, travelers are still forced to sift through mountains of results and crudely weigh the prices of rentable units against the subjective utility derived from each rentable unit's combination of attributes.

The inefficiencies and inconsistencies of existing hotel search websites also impact price information and the booking process. Deal-measurement systems, such as taught herein, can relieve some of the burden borne by travelers searching for hotel accommodations. For a deal measurement system to be entirely effective, however, it must intelligently account for the panoply of additional charges and discounts associated with rentable accommodations. Rentable accommodations, more so than other consumer purchases, are typically accompanied by myriad extra charges and discounts, which may apply in some circumstances but not others. Furthermore, different rentable units often state fees differently, which makes comparing rentable units on an apples-to-apples basis extremely time consuming.

Making matters even more complicated, fee information is often buried in text strings. For example, one rentable unit may state a pet fee of “$80 pet fee per stay non-refundable” and a parking fee of “$25 parking nightly” and an internet fee “$12 per night in-room Wi-Fi”; while a second rentable unit has a pet fee of “$30 per day per pet” and a parking fee of “$30 per day parking” and an internet fee of “complimentary internet”. To compare these two rooms, the prospective traveler must read all the fees, process the meaning of each fee, apply the meaning of each fee in the context of his hotel stay, and combine all fees and discounts with the base price of the room to determine the total price of the room. Multiplying this process by the hundreds of rooms returned in a typical hotel search results in a painful and virtually impossible task for travelers.

Because extra fees and discounts can increase or decrease the price of a rentable unit significantly depending on the situation, any deal-measurement system that fails to intelligently incorporate extra fees and discounts will fail to intelligently measure deals. For example, if Room X is determined to be a better deal than Room Y without consideration of any additional fees, but Room X has a pet fee per night of $40 and a parking fee per night of $30, whereas Room Y charges nothing for pets and parking, then whether Room X or Room Y is the better deal all-things-considered may depend on whether the traveler plans to bring his pet or his car or both. The matter is further complicated by the fact that different fees and discounts may be stated differently and/or buried in a text string. The matter is further complicated by the fact that prices and/or discounts and/or fees are continually changing.

Adding to these troubles is that fact that even after deals have been measured and ranked, travelers searching for hotel accommodations must still examine (or take affirmative steps to filter) numerous results to determine which results not only represent deals but also fall within the market segment sought by the traveler. Typically, travelers must then select a rentable unit for booking, input payment information (i.e., name and credit card information) and room preference information (e.g., non-smoking king bed), and then confirm booking. For instance, if a traveler were searching for luxury hotel suites in Los Angeles, even if the traveler were provided search results for all hotels in Los Angeles ranked according to the discount of the offer price from a model price determined by a price analysis system, the traveler would still have to examine (or take affirmative steps to filter) numerous results to determine which results not only represent deals but also pertain to luxury hotel suites. Typically, the user would have to take further action to select a room for booking, input payment information and room preference information, and then confirm booking.

Accordingly, there is a need for a real-time networked system for splitting rentable units of a hotel that improves the efficiency with which groups of travelers communicate with each other, receive communications from hoteliers, visualize areas to sleep, allocate areas to sleep, allocate price, and collect payments from each other or pay hoteliers together. Additionally, a need exists for a real-time networked rentable unit analysis system that enables travel meta-search engines, hoteliers and others to efficiently associate room-classes with data from multiple data sources and display data from multiple data sources aggregated by room-class; that improves the efficiency with which travelers, hoteliers and others collect, interpret, organize, analyze and display data; that receives or estimates the subjective utility a traveler assigns to one or more attributes of rentable units, receives data about the attributes available at various rentable units, calculates the total subjective utility derived by the traveler from each rentable unit, and ranks the rentable units based on total subjective utility, or subjective utility in relation to price, or subjective utility constrained by a budget; that identifies the best deal in each of one or more market segments—and in some cases preparing one or more rentable units for booking—all effectuated with a single user action, which is indicated to the user by the system; and that supports intelligent incorporation of fees and discounts to facilitate optimal selection of rentable units under varying circumstances.

The system provided herein for suite-splitting, room class matching, rentable unit analysis, attribute utility optimization, single-action deal-classification, and deal-measurement with discretionary incorporation of fees and discounts improves the efficiency with which groups of travelers communicate with each other, receive communications from hoteliers, visualize areas to sleep, allocate areas to sleep, allocate price, and collect payments from each other or pay hoteliers together; improves the efficiency with which travel search engines, hoteliers, travel agents and others collect, aggregate, interpret, organize, analyze, and display data; and improves the efficiency with which travelers find and evaluate rentable units of living space. The efficiencies of the system significantly reduce the number of interactions between the traveler and the source of travel data, while improving consumer choice and supplier pricing. The subsystems taught herein, and each of their individual components, should be understood to integrate with each other, over networks or as part of a stand-alone software platform, to create a system for optimizing the market for rentable units.

Using the Suite-Splitter, travelers may search and select hotel accommodations in real time with other travelers, including linked members in a social network; visualize the layout and sleeping arrangements of selected hotel accommodations with charts, floor plans or other diagrams; create rules for assigning travelers to beds; assign travelers to beds; allocate real-time prices among travelers on the basis of various factors (including their assigned or desired beds); pay for the hotel accommodation via multiple individual payments, or repay a single payer via multiple individual payments; and monitor said payments. Using the Suite-Splitter, hoteliers and travel agents may propose hotel accommodations to connected users in a network; propose the assignment of beds among travelers; propose the allocation of price among travelers based on the assignment of beds in conjunction with other factors; monitor the number of travelers staying in a particular rentable unit to determine if the number conforms with hotel policy; debit or credit travelers' accounts and collect payments from travelers.

The Suite-Splitter system may allocate beds to travelers using an electronic auction system, wherein each traveler in a group submits electronic bids for one or more desired beds until market clearing prices are determined. The electronic auction system may be unique from other auction systems in several respects. A suite has an exogenously determined market price, which can be ascertained at any moment from any number of online travel sites. A bed or other area to sleep in a suite (or even the nondescript right to jointly occupy a suite with a given number of people) also has some value, though heretofore there has been no system for discovering it. One problem faced by travelers on a joint trip is that the values placed on individual beds in a suite, as might be revealed through an auction process, do not necessarily sum to the exogenously determined price of the suite. As such, auctioning each bed individually to members of a group staying in a suite will result in an unpredictable deficit or surplus relative to the exogenously determined price of the suite. This makes conventional, uncoordinated auctions unsuitable for splitting a suite among travelers. What is needed is a modified auction that dynamically adjusts the price to be paid by multiple trip participants in response to receiving a new bid from a trip participant. Such an auction system may involve dynamically adjusting the prices of other beds when the bid for a particular bed changes. Also, since two people often share beds, the auction system may allow a user to submit a joint bid with another user or other users. Other natural variations of an auction system will be apparent to anyone familiar with the Suite-Splitter system. Of course, such a method could prove useful in any number of applications where a good, service or asset with a market price consists of distinguishable sub-assets.

The Suite-Splitter system may allocate beds to travelers on the basis of pre-determined rules and/or rules created by the travelers (e.g., preference for a shared bed in a bedroom may be given to pairs of travelers who are designated as “in a relationship”). The Suite-Splitter may allocate beds to travelers on a first-pay first-serve basis or by any number of methods that will be apparent to those who have read the disclosures herein. The Suite-Splitter may allow users to incorporate connecting rooms into a single event in which the bedding and costs associated with said connecting rooms is allocated.

The allocation of price among travelers may be determined in the same step as the allocation of beds, such as in an auction, or in a separate step. The allocation of price among travelers may be determined at least in part from analysis of the amenities in the room that contains a particular bed (or more generally, the non-communal features assigned to a traveler), such as whether the room has a private bathroom or television. The allocation of price among travelers may be based at least in part on feedback from the travelers themselves, such as voting. The allocation of price among travelers in one group may be based at least in part on the price allocations arrived at by other groups of travelers splitting the same or similar accommodations. The allocation of price among travelers may be based at least in part on input from the hotelier.

Price and availability information may be kept up to date in real time by connecting the Suite-Splitter system to a global distribution system or similar channel known in the art for transmitting real-time price and availability data. Similarly, transactions executed in the Suite-Splitter may be transmitted to travel agents and/or hoteliers in real-time using a global distribution system, another internet-based order processing system, or similar channel known in the art for transmitting real-time transaction data.

The Suite-Splitter system may also receive, process, display and transmit charges in addition to the base price of the hotel accommodations, such as incidental charges, taxes and other fees associated with the stay. The Suite-Splitter system may allocate these charges in the same manner as the base charge for the room, or in another manner.

The Suite-Splitter system may also allow travelers and/or hoteliers and/or travel agents to track payments and charges applicable to each individual in a group of travelers splitting a rentable unit in a hotel.

The Suite-Splitter system may also collect, organize and analyze data generated from its use for a variety of purposes. For instance, as mentioned above, the Suite-Splitter may analyze the manner in which users divide the price of hotel accommodations in order to determine normal or fair price divisions. The Suite-Splitter system may also analyze information generated in the process of splitting hotel accommodations for the purpose of optimizing marketing strategies employed by hoteliers.

The Suite-Splitter system may also facilitate communication between travelers and hoteliers or travel agents. This would enable travelers to ask questions and receive answers from hoteliers or travel agents pertinent to splitting a rentable unit of a hotel with other travelers. Such communication could resolve uncertainty that travelers might have with respect to several topics, such as available bed-layout permutations and the maximum number of occupants in a given rentable unit. The suite splitter system may generate automated alerts when bedding layouts are not guaranteed.

The room class matching system may enable hotel meta-search engines, hoteliers and others to (i) collect price, availability, descriptive information, media and other data from multiple data sources; (ii) create rules and logic for interpreting data; (iii) apply rules and logic to the data received from multiple data sources; (iv) create and apply statistical algorithms to the data received from multiple data sources (v) create rules for associating room-classes with data received from multiple data sources (vi) modify specific room-class associations using a networked interface (vii) and store data with associated room-classes.

To collect data, the system may use a real-time connection to data sources, such as an Application Programming Interface, or use techniques known in the art as crawling and screen scraping, or use other techniques known in the art for data retrieval and transmission. The system may support storing data received from data sources for later retrieval. The rules and logic applied to data collected from various data sources may include text-interpretation rules and pattern-matching logic, such as Regex and other text parsing algorithms. Statistical algorithms applied to data received from data sources may include techniques for measuring the likelihood that data from an inventory source is associated with a room-class. For example, the system may apply Term-Frequency Inverse-Document-Frequency algorithms to determine which terms within the name descriptions collected from an inventory source are the best predictors of room-classes. As an alternative or additional statistical technique, the system may calculate the difference between prices from different inventory sources as an inverse measure of the likelihood that the prices are associated with the same room class. The system may overlay rules, additional statistics, machine learning algorithms and the like for synthesizing statistical measures to associate one or more room-classes with data received from data sources. The system may enable administrators to modify room-class associations using an interface. As a result of the efficiencies provided by the system, data received from data sources can be optimally and efficiently associated with room-classes, which facilitates comparison and analysis of data received from multiple inventory sources.

The room-class matching system may also allow hotel meta-search engines and others to analyze data. For example, after associating defined room-classes with price data received from multiple inventory sources, the system may apply rules and logic to determine which inventory source offers the lowest price with regard to a particular room-class of a particular hotel on a particular date. Such analysis may include an evaluation of fees and other charges associated with each inventory source. Such analysis may include an evaluation of commissions or other payment agreements with each inventory source. The room-class matching system may also support a platform to identify whether prices offered with regard to a room-class constitute a deal, based on criteria. The room-class matching system may also allow hoteliers and others to efficiently monitor compliance with pricing policies by identifying whether prices offered with regard to a room class constitute a violation of pricing policy, based on criteria. The system may support a platform that keeps hoteliers and others apprised of compliance by various parties with pricing policies using alerts and other communications, graphs, charts, diagrams and statistics. The system may calculate and suggest prices for various sellers of travel to enable them to comply with pricing policies or to respond to market conditions.

The room-class matching system may enable travelers to view data organized by room-class using an online interface. The system may support ranking of room-classes and/or ranking of inventory sources within each room-class. The system may support rules for prominently displaying the inventory source with the lowest price within each room class at a hotel. The system may support or integrate with a real-time reservation system, allowing travelers to complete reservations using an online shopping cart. The system may support an internet-based order processing system to facilitate payment for reservations.

The room-class matching system may facilitate communication among and between meta-search engines, hoteliers, other travel sellers, and/or travelers. Communication may play an important role in resolving ambiguities with respect to the association of room-classes with data received from data sources. The system may support an online interface used by hoteliers and distribution systems to tag data with universal room-class identification codes.

The rentable unit analysis system may support one or more of the following: (i) collecting and organizing price data, availability data, amenities data, descriptive summaries, media, reviews, geographical data, meteorological data, news, events and calendar data, social media data and other data; (ii) creating and applying rules, logic and statistical algorithms to translate data received from data sources into values of variables suitable for quantitative analysis; (iii) creating and applying rules, logic and statistical algorithms to associate hotels, room-classes and/or rooms with data received from data sources; (iii) creating and applying rules, logic and statistical algorithms to evaluate, rate the aggregate quality of, and/or model the aggregate price-level of one or more market segments on one or more dates; (iv) creating and applying rules, logic and statistical algorithms to evaluate, rate the quality of, estimate the fair value of, and/or predict the price of one or more rentable units on one or more dates; (v) displaying data, analysis and conclusions on a networked user interface; (vi) facilitating an online reservation and order processing system; (vii) facilitating an online opaque reservation system or auction system in which users are shown only limited information about a rentable unit prior to booking it.

To collect and organize data, the system may use a real-time connection to data sources, such as an Application Programming Interface, or use techniques known in the art as crawling and screen scraping, or use other techniques known in the art for data retrieval and transmission. The system may support storing data for later retrieval. Data sources may include inventory sources, travel data providers, media providers, meteorological data providers such as the National Weather Service, news aggregators, and location based data providers such as Google Maps. Administrators may be equipped with an online interface for entering or modifying data. The system may store data that has been collected and organized.

When translating data received from data sources into values of variables suitable for quantitative analysis, the system may apply text-interpretation rules, pattern-matching logic, as well as other rules and logic. For instance, the system may receive one or more text descriptions containing “square footage: 500” or “five hundred sq. ft.” or “47 meters squared”; the system would parse the description using pattern matching logic and recognized patterns stored in a networked database, convert units of measure to a standard unit of measure, and store the number “500” as the value of the square footage variable pertaining to a particular room or room-class. The system may apply statistical algorithms to determine the most likely value of variables when more than one value is possible based on the data received from data sources. The system may support an online interface enabling administrators to modify the rules and logic applied to data and/or enabling administrators to modify either the raw data received from data sources (such as by rewriting descriptions) or the variable values derived from that data.

The rules and logic applied to data for the purpose of associating hotels, rooms and room classes with data may include text-interpretation rules and pattern-matching logic. Statistical algorithms applied to data received from various data sources may include techniques for measuring the likelihood that data from a data source is associated with a room-class. For example, the system may apply Term-Frequency Inverse-Document-Frequency algorithms to determine which terms within the name descriptions collected from an inventory source are the best identifiers of room-classes. As an alternative or additional technique, the system may calculate the difference between prices from different inventory sources as an inverse measure of the likelihood that the prices are associated with the same room class. The system may overlay rules, additional statistics, machine learning algorithms and the like for synthesizing statistical measures to associate one or more room-classes with data received from data sources.

When rating the aggregate quality of or modeling the aggregate price-level of a market segment on one or more dates, the system may analyze the current or historical prices of rentable units in that market segment on comparable dates, the current or historical prices of rentable units in other market segment on comparable dates, and characteristics of the market segment or rentable units therein including weather conditions and seasonal factors, geographical factors (e.g., proximity to beaches) and cultural factors (e.g., number of landmarks), socio-economic factors, availability and quality of leisure activities (e.g., restaurants and movie theatres), supply and characteristics of rentable units in the market segment, demand for rentable units in the market segment, expert reviews or industry awards, community reviews or other crowd-based intelligence, user preferences, user location, and statistical relationships between the aggregate price level of the market segment and the aggregate price level of other market segments. The system may create market segments based on geographical area, hotel ratings, price points, travel themes, aesthetic themes, or any combination thereof. The system may compare the model price-level of a market segment with the actual price-level of the market segment to determine the extent to which the market segment is cheap or expensive and/or the extent to which the price-level of the market segment is predicted to rise or fall.

When rating the quality of rentable units, the system may analyze subjective and objective characteristics associated with the rentable unit including one or more of the following: market segments associated with the rentable unit, expert reviews or industry awards, community reviews or other crowd-based intelligence, user preferences, user location in relation to the rentable unit, supply, demand, physical characteristics, amenities, complimentary perks or services, view, relative or absolute floor position, and location of the rentable unit in relation to other businesses, rentable units, landmarks, and geographical points of interest. Because some of these characteristics are qualitative in nature and procured from third-party data sources, some characteristics will only be susceptible to statistical analysis subsequent to the text interpretation and standardization routines described elsewhere herein. In one example, after translating text into quantitative variables suitable for analysis, the system may utilize modeling techniques described elsewhere herein to estimate the relationship between price and characteristics of rentable units; the system may then assign normalized ratings to each rentable unit based on the price implied by its bundle of characteristics, such as by assigning scores of 9.9 to those rooms with implied prices in the 99^{th} percentile of the data set, and so on. In another example, the system may assign ratings based on which bundles of characteristics are hardest to find and/or most sought. For instance, the system may estimate the joint probability of encountering a bundle of characteristics at least as good as those offered by a hotel room by first calculating the frequency of encountering an individual characteristic in a sample or population of hotel rooms, and then calculating the product of those frequencies (if characteristics were correlated, then conditional probabilities of characteristics could be calculated before calculating their products); the system could then assign a rarity measure proportional to the inverse of the probability of encountering a bundle of characteristics at least as good as those offered by the hotel room. As a specific example, but by no means a limiting example, a hotel room may offer the following characteristic vector: squarefeet=850, stars=4. The system may calculate that the probability of a room being 850 square feet or bigger is 0.02, that the probability of a room belonging to at least a four-star hotel is 0.5, and that there is no correlation or other dependence between these two characteristics. As such, the probability of finding a room that has both of those characteristics or better can be calculated as 0.02*0.5=0.01, which could produce a rarity measure of 1/0.01=100. The room could then be assigned a normalized score according to the percentile ranking of its rarity measure relative to all rarity measures calculated in the sample or population of hotel rooms.

In yet another example related to determining the quality of an accommodation, the system may measure the quality of a location or landmark view based on the web-footprint or social media footprint associated with that location or landmark, including number of search results returned in a query for the location or landmark, number of tweets, check-ins, posts or other social media associated with the location or landmark, and so on. In another example, the system may rate the quality of a view by (i) drawing straight lines emanating from the latitude, longitude, elevation and direction of a hotel room window and (ii) counting the number of such straight lines that reach a landmark or other point of interest without being broken by an intervening object known by the system to exist across the latitudes, longitudes and elevations traveled by that straight line on its way from the view source to the landmark of interest.

When modeling the price of rentable units, the system may analyze subjective and objective characteristics associated with the rentable unit including one or more of the following: current or historical prices of the rentable unit or comparable rentable units, actual or modeled price levels of the one or more market segments associated with the rentable unit, expert reviews or industry awards, community reviews or other crowd-based intelligence, user preferences, supply, location relative to user, demand (as measured by purchases, clicks, views, queries, or similar activity), physical characteristics, amenities, complimentary perks or services, view, relative or absolute floor position, and location in relation to other businesses, rentable units, landmarks, and geographical points of interest. Because some of these characteristics are qualitative in nature and not standardized when transmitted from third-party data sources, some characteristics will only be susceptible to statistical analysis subsequent to text interpretation and standardization routines. In one example, after translating text into quantitative variables suitable for analysis using pattern matching logic and maximum likelihood estimation as described elsewhere herein, the system may utilize econometric techniques to determine a model price for each rentable unit based on its bundle of characteristics. In another implementation, the system may create similarity indices using the variable values described above to determine a set of comparable rentable units, or a comparable composite index, from which to extrapolate or interpolate the price of a rentable unit. In another implementation, the system may model prices hierarchically or recursively using a series of differences. An example of a recursive modeling of rentable units using differences is this: first model the expected price level of market segments based on market characteristics; next, add to the model an expected difference between (a) the price level of the base room-class of the hotel under examination and (b) the price level of the typical base room-class of the market segment to which that hotel belongs, where this expected difference is a function of the difference between (c) the characteristics of the hotel under examination and (d) the typical characteristics offered by a hotel in that market segment; next add to the model the expected difference between (e) the price level of a specific room-class (or room) within the hotel under examination and (f) the price level of the base room-class of the hotel under examination, where this expected difference is a function of the difference between (g) the characteristics offered by the specific room or room-class under examination and (h) the amenities offered by the base room class; next add to the model the expected difference between (m) the price level of the specific room on specific dates and (n) the expected price of the specific room on typical dates, where this expected difference is a function of the difference between (p) general price levels in the same market or similar markets on the specific dates and (q) those same general price levels on typical nights. For instance, the system may first determine that the expected price of a hotel on the corner of Santa Monica Boulevard and Charleville Boulevard in Beverly Hills is $200 on Tuesday nights by distance-weighted averaging the prices of all surrounding hotels observed on Tuesday nights; the system may then determine that a base-class room at the Peninsula is worth $100 per night more than the distance-weighted composite average hotel due to the superior standard amenities offered by the Peninsula; the system may then determine that the Villa King Room at the Peninsula is worth $75 more than the base room at the Peninsula, due to the superior amenities offered by the Villa King room; the system may then determine that on the particular dates searched by the user, the Villa King room is worth $50 less than normal because of a general depression of prices in Los Angeles on those dates. Such a structured approach, tending to move from broad to narrow assessments, is extremely useful in this context because correlation among hotel characteristics, room characteristics, and market-segment characteristics will confound standard statistical techniques (e.g., regression) due to a phenomenon known as multicollinearity. Simply put, without this unique and nuanced recursion, statistical techniques generally cannot determine the extent to which prices are driven higher by (i) being surrounded by other expensive hotels or (ii) having good hotel ratings and hotel amenities or (iii) having lavish rooms with many room amenities—since all of these attractive characteristics tend to occur together or not at all.

In yet another implementation, the system may use any of a variety of expectations-equilibrium models to determine the equilibrium price of rentable units given fixed supply, rational profit maximizing vendors, and demand that is in part stochastic and in part formulated in response to price expectations. The system may compare the model price of a rentable unit with the actual price at which the rentable unit is being offered to determine the extent to which the rentable unit is cheap or expensive and/or the extent to which the price of the rentable unit is predicted to rise or fall.

The system may facilitate the comparison of refundable stays with non-refundable stays. Often, travelers are given the choice between refundable stays and non-refundable stays, with refundable stays generally being meaningfully more expensive to account for the benefit the traveler receives from being able to change his mind if conditions change such that the value of the stay falls below the refundable amount. The ability to refund the purchase of a hotel stay can be viewed as an embedded option and priced using an options pricing model. The system may contain logic and algorithms for evaluating the price difference between refundable stays and nonrefundable stays using an options pricing model, such as the Black-Scholes-Merton model, where the inputs to the model may include (among others) the historical volatility of room prices and the amount of the purchase price that is refundable.

The system may support an online user interface to enable users to visualize and interact with data, analysis and conclusions. In one implementation, the system may provide a display page with graphs or histograms showing the number of hotels, room-classes or rooms that have been identified by the system as possessing one or more characteristics. The display may enable the user to select a portion of the graph or histogram to reveal the hotels, room-classes or rooms that fall within the selected portion of the graph or histogram. For example, the user may be presented with a histogram depicting the distribution of hotel room-classes by square-footage in Las Vegas. The user may then select a range of the histogram by clicking, dragging or taking other actions with respect to the display to see room-classes in Las Vegas whose square footages fall within the selected range. The user actions taken with respect to the histogram may filter or sort results in a separate or integrated list of available rooms. Furthermore, the user may be equipped with a marking mechanism to express a degree of preference for attributes represented by the histogram. For instance, the histogram may display the distribution of different views available in New York (e.g., “city” “water” and “Times Square”), and the user may be enabled to indicate with respect to each such view (or a user defined collection of views) “I Want”, “I Need”, or “I Don't Care”. The user actions taken with respect to the histogram may filter or sort results in a separate or integrated list of available rooms based on the users indicated preferences. It will be understood based on the disclosure provided herein that the maps, time graphs, histograms, etc. all interact/merge to provide a highly functional graphical interface.

In another implementation of an online interface enabling the user to visualize and interact with data, the system may provide a display page with a graph supporting the depiction of (i) aggregate price-levels in one or more market segments across time; (ii) prices of individual hotels, room-classes, rooms or other rentable units across time; (iii) availability of hotels, room-classes, rooms or other rentable units across time across time; (iv) levels of meteorological variables associated with market segments, hotels, room-classes, rooms or other rentable units across time; (v) events associated with market segments, hotels, room-classes, rooms or other rentable units across time; and/or (vi) price-levels of other travel products, such as the price of airfare and rental cars. For instance, the system may support a display in which time is depicted on the x-axis starting with the current date and extending into the future as the graph extends rightward, the aggregate (average, minimum or other composite) price-level in one or more geographical areas is depicted for each night using a line graph with price on a first y-axis, the number of available units in the one or more geographical areas is depicted for each night using bars below the line graph on a second y-axis, the temperature and precipitation in the one or more geographical areas are depicted for each night using bars, colors and/or symbols above the line graph on a third y-axis, and events in the one or more geographical areas are depicted using flags or clickable information bubbles. Events may be public events stored in the system for each location (e.g., Consumer Electronics Show in Las Vegas), or may be personal events retrieved from a user's personal electronic calendar (e.g., mom & dad's anniversary) using an application programming interface. Furthermore, events on this time graph may correspond to a similarly labeled or colored marker on a map; and the interface may allow the user to perform an action (such as clicking) with respect to the event-flag on the time graph to reveal its location on a map. In one embodiment, as the user filters search results—such as by constraining results to only those rooms above 500 square feet with Jacuzzi tubs—the composite price level graph and room availability graph may exclude all prices and available rooms, respectively, that do not meet the filter criteria. This enables the user to quickly and intuitively view a graph of prices on potential future travel dates for exactly those rooms that the user would consider occupying. Of course, other variations will be obvious to those familiar with the system. Furthermore, the system may enable the user to select market segments, hotels, room-classes and/or rooms for inclusion or exclusion in the display by clicking, dragging or taking other actions. Further, the system may enable the user to adjust the dates of a search for rentable units by clicking, dragging or taking other actions with respect to the time axis of the display. Furthermore, the system may integrate with a calendar of events, which may be events of general interest or import, events populated based on preferences of the user, or events populated from the user's calendar.

In yet another implementation, the system may support an interactive map enabling users to visualize data, analysis and conclusions spatially with map markers and overlays. For example, the system may integrate with a map application and, as part of that integration, serve markers and overlays to the map application, with the markers and overlays being generated by the system from data, analysis and conclusions stored in association with latitudes, longitudes and elevations. The markers and overlays may represent regions, cities, neighborhoods, areas, hotels, room-classes or rooms—depending on the zoom level of the map. For example, when the map zoom is beyond a threshold, the system may serve colored overlays to the map application indicating whether the price-level in a city is above the model price for that city (red overlay), below the model price for that city (green overlay), or about the same as the model price for that city (yellow overlay). As the user zooms in, an event callback is triggered prompting the system to serve new colored overlays to the map application indicating whether the price-levels in neighborhoods are above or below their model price levels. As the user zooms in further, an event callback is triggered prompting the system to serve hotel markers to the map application indicating whether prices at hotels are above or below their model price levels. As the user zooms in further, an event callback is triggered prompting the system to serve new colored hotel markers to the map application indicating whether prices of room-classes at hotels are above or below their model price levels; the markers may be characterized by vertical layers, with the color of each layer representing whether the price of one or more room-classes is above or below the applicable model price (and the position of layers may indicate the relative quality of the room class, such as by placing the Penthouse as the highest colored layer in a hotel marker). As the user zooms in further, an event callback is triggered prompting the system to serve colored hotel diagrams to the map application indicating whether rentable units within a hotel are above or below their model values; the hotel diagrams may display the position of each rentable unit within the hotel, with the color of each rentable unit representing whether its price is above or below its model price. This recursive process of zooming and replacing colored markers with more detailed colored markers may terminate at a three-dimensional model of the hotel enabling the user to virtually navigate through building(s) with each room colored to indicate the relationship between the price of the room and its model value. The map display may be integrated with the price-graph display described above or with a calendar search interface, such that when a user selects different time frames, the map overlays are updated according to the data, analysis and conclusions associated with the new time frame. The attribute histograms, price-time graphs and maps may be integrated to form a graphical system of search refinement enabling the user to seamlessly transition between graphically refining a search on the dimension of space, graphically refining a search on the dimension of time, and graphically refining a search on the dimensions of hotel or room characteristics. For instance, swiping functionality or the use of light-box overlays may enable the user to toggle from one type of graphical filter to another while refining a search. In another implementation, the system may support the display of a hotel icon in which the number of lights illuminated in the icon indicate the quality of the hotel, room-class or room.

The system may support alerts, warnings and updates communicated via visual displays, emails, tweets, messages, and the like to guide users toward optimal decisions based on criteria including user preferences, quality ratings, price analysis and the like. In one implementation, the system generates and displays an alert when the user selects a rentable unit and there exists at least one other rentable unit whose quality rating is at least as high as the quality rating of the selected rentable unit and whose price is lower than the price of the selected rentable unit on the selected dates. In another implementation, the system generates and displays an alert when the user selects a rentable unit and there exists at least one other rentable unit that satisfies at least as many of the user's preferences as the selected rentable unit and whose price is lower than the price of the selected rentable unit on the selected dates. In another implementation, the system generates and displays an alert when the user selects a rentable unit and there exists at least one other rentable unit whose amenities scores are each at least as high as the corresponding amenities scores of the selected unit and whose price is lower than the price of the selected unit. In yet another implementation, the system generates, displays and emails an alert if the user has booked a refundable rentable unit and the system later determines that exercising the option to refund the purchase price is optimal. In yet another implementation, the system generates, displays and emails an alert when the price-level of a market segment or the price of a rentable unit deviates from a model price by a sufficient amount.

The system may support a user-directed platform for assessing special rates that are not generally available to the public or rates that the user found outside of the system, including rates that are only available to groups, members of travel clubs or other membership clubs. In one embodiment, the user provides the system with the following criteria for assessment: (i) specific travel dates (or a range of possible travel dates), (ii) a hotel name or other identifier, (iii) a room-type name or other room-type identifier, and (iv) the user-provided rate associated with the stay. The system may compare the user-provided rate with a rate generated by a model, such as the models described herein, and display to the user the difference between the user-provided rate and the model rate. Furthermore, the system may display for the user one or more room-types within a given radius of the user-provided hotel that (i) meet a quality threshold in relation to the room-type being assessed by the user (e.g., displayed rooms must have a quality score equal to or greater than the quality score of the room-type being assessed by the user) and (ii) meet a value threshold in relation to the room-type being assessed by the user (e.g., displayed rooms must have a price lower than the room-type being assessed by the user and/or value grade higher than the room-type being assessed by the user). In this way, the user is not limited by the inventory sources available in the system; rather, the user can leverage the efficiencies provided by the system even when examining rates and special offers that are not known to the system prior to that user's interaction with the system.

The system may support the sharing of displays, maps, floor plans, media, data, analysis, and conclusions via social media and email. In one implementation, the system allows a user to share ratings, evaluations, and price estimates with respect to a rentable unit by clicking a share button associated with each listed rentable unit.

The system may support a revenue management system, or integrate with external revenue management systems, to facilitate optimal pricing of rentable units by hoteliers and travel agents. Generally speaking, revenue management involves generating a schedule of prices that maximizes expected revenue or expected profit given expectations about supply, demand and competition. To forecast demand for rentable units at different price levels (i.e., to forecast the demand curve), hoteliers and travel agents must understand the competitive landscape, which requires comparing the characteristics of rentable units. The system described herein facilitates the standardization, quantification and comparison of characteristics of rentable units. The system may recommend prices to hoteliers and travel agents to optimize objectives. In one implementation, the system may identify rentable units that are substitutes with respect to a rentable unit of interest to a hotelier based on characteristics of the units; the system may then incorporate actual prices or forecasted prices of the substitute rentable units when creating a demand function for the rentable unit of interest; the demand function so created may then be analyzed in conjunction with a supply function and profit function to determine the optimal price of the rentable unit of interest.

The system may support or integrate with a real-time reservation system and order processing system. The efficiencies of the system may facilitate opaque booking with respect to suites and other non-standard rooms that are typically not offered in opaque booking channels. Opaque booking describes a booking process in which travelers are shown only limited information prior to a nonrefundable purchase. In general, opaque booking facilitates profit-maximizing market discrimination by hoteliers and travel agents by identifying travelers who are not brand sensitive. However, travelers generally need some information to ensure that the rentable unit will satisfy their objectives. For that reason, opaque booking channels generally show travelers the star-rating and general location of the hotel being booked. Until now, opaque booking has not been economical in room-classes other than the cheapest room class of a hotel because until now there has been no efficient way to modulate the amount of information shown to travelers, as characteristics of rentable units are generally stored in long text descriptions that must either be shown in totality or not shown at all. The system described herein facilitates showing travelers partial information or obscured information to promote opaque booking in all room classes. For example, after generating the value of the square footage variable from a text description for a rentable unit being offered through an opaque booking channel, the system may show the traveler only a range in which that value falls rather than the precise value: the system may determine that the square footage of a rentable unit is 535, but only show the traveler that the square footage is between 500 and 600. The system may suggest prices to hoteliers and travel agents offering rentable units through the opaque booking channel and/or restrict rentable units from the channel whose prices exceed predetermined or dynamically determined ratios with respect to a model price.

Within the Attribute Utility Optimization System, travelers may use an online interface to search for and select rentable units of living space in real time; input their perception of the utility conferred by attributes associated with rentable units; create rules for ranking rentable units based on conferred utility and price; and visualize the available trade-off between price and utility of rentable units with charts, graphs and diagrams. Administrators may also use an online interface to create rules for ranking rentable units based on conferred utility and price. The system may also use a real-time connection to hotel inventory systems to support a platform for opaque bidding, wherein a traveler indicates the subjective utility conferred by attributes, and the system matches the traveler with one or more undisclosed rentable units offered by hoteliers within the opaque bidding system based on an objective function, such as maximizing the utility per dollar received by the traveler; the system may require the traveler to commit to purchasing the rentable unit before placing a bid.

Within the Attribute Utility Optimization System, several travelers who intend to split a rentable unit may use an online interface to search for and select rentable units of living space in real time together; separately input each of their individual perceptions of the utility conferred by attributes associated with rentable units; create rules for ranking rentable units based on the utility conferred to various members of the group and price; and visualize the available trade-offs with charts, graphs and diagrams.

Within the Attribute Utility Optimization System, hoteliers and travel agents may use an online interface to create rules for segmenting the market into categories of travelers and/or destinations; request data regarding the perceived utility of amenities according to travelers in one or more market segments; collect, organize, and analyze data generated by travelers in one or more market segments; visualize the perceived utility of amenities according to travelers in one or more market segments using charts, graphs, and diagrams; and determine market prices based on the supply of and demand for various combinations of attributes in various geographic locations at various times.

The Attribute Utility Optimization System may allow travelers to express the perceived utility of attributes on a scale measured in dollars, on an integer scale with no unit of measure, in affine space, in an ordinal ranking, using visual indicators, and/or using verbal indicators. By way of example but not limitation, a traveler expressing the perceived utility of attributes on a scale measured in dollars might indicate that Attribute X is worth $20 while Attribute Y is worth $50; a traveler expressing the perceived utility of attributes on an unspecified integer scale might indicate that Attribute X has utility of 2 while Attribute Y has utility of 3; a traveler expressing the perceived utility of attributes in affine space might indicate the position of Attribute Y and Attribute X along a line; a traveler expressing the perceived utility of attributes in an ordinal ranking might order amenities from highest perceived utility to lowest perceived utility, or might assign words to attributes expressing intensity of desire, such as “want,” “need,” “not important,” “most important” and so on. In this way, travelers are enabled to indicate their desires for attributes of rentable units with greater precision than permitted by mere binary indications.

The Attribute Utility Optimization system may infer a traveler's preferences with regard to various attributes by applying statistical analysis to rentable units that the traveler has “liked” or “disliked”; or rentable units that the traveler has clicked on, hovered over, or interacted with in any other way that could be recognized by an online interface. In one example, each rentable unit could be assigned an attribute vector indicating the presence or level of various attributes associated with that rentable unit; travelers could “like” or “dislike” rentable units using an online interface; and entropy loss or other statistical measures could be used to determine the likelihood that the traveler favors or disfavors particular attributes and with what intensity. The system may also infer traveler indications of utility based on analysis of the social connections of the traveler, or based on analysis of other travelers who exhibit similar social profiles.

The Attribute Utility Optimization System may allow travelers to indicate the perceived utility of attributes before, after or coincident with a search for prices and availability of rentable units. For instance, a traveler may submit a query over a network for prices and availability of hotels in Los Angeles and also submit indications of the perceived utility of various attributes, with the latter occurring before, after or at the same time as the former. Price and availability information may be kept up-to-date in real time by connecting the system to a global distribution system or similar channel known in the art for transmitting real-time price and availability data. The system may also receive, process, display and transmit charges in addition to the base price of the rentable unit, such as facilities charges, taxes and other fees. These fees may be incorporated into the price of the rentable unit either at the discretion of the user or automatically. The system may also receive, process, display and transmit data related to the amenities of rentable units, such as by receiving updates through a connection to a hotel's central reservation system or other data source maintained by the hotel. The system may utilize all of the processes for interpreting and analyzing data taught elsewhere herein.

Travelers or administrators may create rules for ranking and/or filtering rentable units based on conferred utility and price. For instance, a traveler or administrator may create a simple rule to rank rentable units in order of utility per dollar, calculated as the sum of the utility conferred by each attribute of a rentable unit divided by the price of the rentable unit. In a more complex example, administrators may create preliminary rules to determine how much utility a traveler with given preferences derives from a particular level or quality metric associated with an attribute of a rentable unit. For instance, an administrator may create a rule that calculates the utility derived from an attribute as the product of a preference score that a traveler assigns to the attribute and a quality score associated with an attribute of a particular rentable unit. In one example, using that method, if a traveler assigned an importance level of 5 to the room size attribute, and the room size attribute associated with a particular rentable unit had a value of 9, then the utility derived from the room size of that particular rentable unit could be calculated under the proposed method as 5 times 9 equals 45. The utility conferred by that attribute could then be added to the utility conferred by all other attributes of that rentable unit to determine the total utility conferred by that rentable unit. Other rules for determining the utility conferred by rentable units, and for ranking rentable units based on utility and other factors, will be obvious to those skilled in the art.

The Attribute Utility Optimization System may support an interface that allows travelers to visualize trade-offs between the utility of rentable units and/or the utility of rentable units in relation to their prices. For instance, the system may enable a traveler to plot the subjective utility of a rentable unit on the x-axis and the price of the rentable unit on the y-axis to enable travelers to quickly identify those rentable units that deviate from the line of best fit. Of course, other implementations to visualize data will be obvious to those who have become familiar with the system.

The Attribute Utility Optimization System may use caching, login credentials, or other mechanisms to preserve traveler indications of utility from one session to the next. The system may also enable alerts to inform travelers when a rentable unit is available for a price that is attractive in comparison to the subjective value placed on the attributes of the rentable unit by the traveler. The system may support a variety of other communications to keep travelers, administrators, hoteliers and others apprised of the analysis generated by the system.

The Attribute Utility Optimization System may also collect, organize and analyze data generated by travelers for a variety of purposes. Because hoteliers and travel agents must continually adapt to traveler preferences, the system is provided to allow these merchants to optimize their businesses. The system may collect, organize and analyze information for the purpose of optimizing marketing strategies employed by hoteliers and online travel agencies. The system may collect, organize and analyze information for the purpose of enabling hoteliers to evaluate which amenities are most highly valued by travelers and/or will result in the highest return on investment. The system may also propose market-clearing prices of rentable units based on an evaluation of the individual attributes associated with the rentable units. The market-clearing price may be calibrated and made available on a real-time basis. The market-clearing price may be determined based on the demand for particular attributes and the availability of particular attributes in one or more geographic locations. Of course, because availability and demand differ depending on the date of travel, the market-clearing price for the same combination of amenities may differ depending on the travel dates. The system may be integrated with existing revenue management systems utilized by hoteliers and travel agents.

The Attribute Utility Optimization System may be integrated with the Suite Splitter system taught herein to enable groups of travelers to optimize, balance and/or control the allocation of utility and price among group members. For instance, an administrator or traveler may use an online interface to create a rule that identifies and/or books the rentable unit that maximizes the total utility of the group, or minimizes the variance of utility across members of the group, or minimizes the variance of utility per dollar contributed to the trip across members of the group. Such rules are useful in minimizing bickering among travelers engaged in a group trip. Other rules will be obvious to those skilled in the art.

The single-action deal-classification system may enable travelers to execute any of the following integrated processes with a single-action using an online interface: (i) find the best deal in each of one or more market segments; (ii) prepare for booking the best deal identified across multiple market segments or the best deal identified in a preferred market segment; and/or (iii) book the best deal identified across multiple market segments or the best deal identified in a preferred market segment.

The single-action deal-classification system enables travelers to find the best deal in each of one or more market segments by supporting a platform that may include one or more of the following: (i) collecting price, availability, descriptive information, media, reviews and other data; (ii) creating and applying rules, logic and statistical algorithms to interpret and categorize data; (iv) creating and applying rules and logic to measure the extent to which prices differ from model values; (v) creating and applying rules and logic for partitioning rentable units into market segments; (vi) creating and applying rules and logic for identifying the best deal in each market segment; and (vii) displaying the best deal in each market segment with information that identifies the applicable market segment to the user.

To collect data, the system may use a real-time connection to data sources, such as an Application Programming Interface, or use techniques known in the art as crawling and screen scraping, or use other techniques known in the art for data retrieval and transmission. The system may support storing collected data for later retrieval. The rules and logic applied to data collected from various data sources may include text-interpretation rules and pattern-matching logic. The system may support all of the rules, logic and techniques taught elsewhere herein for measuring deals, discounts and the like. The system may support all of the rules, logic, and techniques taught elsewhere herein for associating data received from external data sources with room-classes.

The system may support rules and logic for partitioning a market into segments based on data associated with rentable units. For example, in one embodiment, a traveler submits a search query for rentable units in a city during a date range from a client device; based on the traveler request, the system requests availability and price data from an inventory distribution service over a programming interface; upon receiving price and availability data from the inventory distribution service, the system partitions the available rentable units into 3-quantiles on the basis of price, with the first quantile containing the cheapest one-third of rentable units in the results, the third quantile containing the most expensive one-third of rentable units in the results, and the second quantile containing the rentable units with prices in the middle. In another implementation, as a preliminary step to the market segmentation step, the system may assign a score to rentable units based on criteria indicative of quality. After each rentable unit has been assigned a quality score, the system may assign rentable units into 3-quantiles on the basis of quality, with the first quantile containing the lowest quality rentable units, the second quantile containing the middle quality rentable units, and the third quantile containing the highest quality rentable units. When assigning quality scores to rentable units, the system may consider amenities, location, reviews and other characteristics associated with each rentable unit. When assigning quality scores to rentable units, the system may consider price data to determine the market value of various characteristics. When assigning quality scores to rentable units, the system may incorporate information relevant to the preferences of the user, including feedback received from the user or information related to the social profile of the user. The system may store user preferences along with identifiers of the user or the user device. In another implementation, the system may partition the market into neighborhoods. The system may integrate with a global positioning system in the user's device and partition the market based on the distance of the rentable unit from the user (e.g., “walking distance”, “biking distance”, “cab ride”). The system may partition the market based on hotel rating (e.g., “5 stars”, “4 stars”, and so on). The system may partition the market based on travel themes or aesthetic themes. Of course, various partitions and criteria for partitioning the market will become obvious to those skilled in the art. It should be understood that the system may partition rentable units into market segments based on stored data prior to receiving a traveler search request, or may partition rentable units into market segments dynamically based on results returned from one or more inventory distribution services in response to a traveler search request.

Once rentable units have been grouped in market segments, the system may use rules and logic to determine the best deal within each market segment. For example, in one embodiment, after dividing the market into 3-quantiles of rentable units on the basis of a quality measure, the system may identify the rentable unit within each quantile whose price exhibits the largest discount from a model price calculated by the system based on the characteristics of the rentable unit and price data. The system may then display only those rentable units identified as the best deal in their respective market segments to the user, along with information identifying the market segment partitions to the user. The system may also support an online user interface to facilitate the modification of the above rules and routines.

The single-action deal-classification system may also prepare for booking the best deal identified across multiple market segments or the best deal identified in a preferred market segment. For example, in one embodiment, rather than displaying the best deal in each market segment to the user, the system may determine which rentable unit from among the best deals in one or more market segments the user would select with highest probability; and populate summary information related to the rentable unit and/or purchaser identifying information into a booking step wherein the user either confirms or cancels the booking. To determine which rentable unit from among the best deals in one or more market segments the user would select with highest probability, the system may collect and store information about the purchase history, click history, or search history of the user or the user's device; store preference information associated with the user or the user's device; store social-profile information associated with the user or the user's device; and evaluate said user information in relation to those rentable units that have been identified as the best deal in each market segment. The information about rentable units evaluated in determining which rentable unit the user would most likely select may include reviews, attributes, current prices, historical prices, model prices, location and other characteristics. For instance, if the client device identified as sending the search request to the server has in the past purchased primarily luxury suites (based on purchase history information associated with the client device by the system), then after partitioning the market into segments, the system may prepare for booking the best deal in the luxury suite market segment. In other embodiments, the user may commit to booking the rentable unit selected by the system, subject to a maximum price, prior to learning the identity of the rentable unit, such as in an opaque booking channel. In that case, the user may not need to confirm or cancel the booking. As such, in that embodiment, a single user action effectuates both the identification and booking of the best deal in the market segment that the user would most likely select from among one or more market segments. The system may also support an Internet-based order processing system to facilitate booking.

Through the deal-measurement system with discretionary incorporation of fees and discounts, travelers may use an online interface to (i) view standardized information about fees and discounts associated with rentable units, (ii) indicate which fees and discounts are relevant in a search for rentable units, (iii) and/or evaluate the extent to which rentable units constitute deals after incorporating fees and discounts in light of the traveler's particular situation.

The system enables travelers to make efficient use of fee and discount information by supporting a platform that facilitates (i) collecting fee information, discount information and other data; (ii) creating and applying rules, logic and statistical algorithms to interpret the fee information, discount information and other data; (iii) collecting information and applying rules, logic and statistical algorithms to determine what fees and discounts pertain or are likely to pertain to a user; (iv) and incorporating pertinent fees and discounts into an analysis of the price of the room.

To collect data, the system may use a real-time connection to data sources, such as an Application Programming Interface, or use techniques known in the art as crawling and screen scraping, or use other techniques known in the art for data retrieval and transmission. The system may support storing collected data for later retrieval. The rules and logic utilized to interpret fee and discount information may include text-interpretation rules and pattern-matching logic. Statistical algorithms applied to data may include techniques for measuring the likelihood that a text description describes a particular fee or discount. For example, the system may apply Term-Frequency Inverse-Document-Frequency algorithms to determine which terms within a descriptions collected from a data source are the most reliable identifiers of particular fees. The system may include logic for comparing and standardizing fees and discounts expressed in differing units of measure, including fees measured on a per night, per day, per stay, per occupant, or per occupant per night basis. The system may support all of the rules, logic and techniques taught elsewhere herein for measuring deals, discounts and the like. The system may support all of the rules, logic and techniques taught elsewhere herein for determining which fees and/or discounts pertain to which room-classes. The system may include a user interface that enables travelers to indicate which fees and discounts are applicable in a given search for rentable units. The system may support rules, logic and statistical algorithms for predicting which fees and/or discounts are pertinent to a user without requiring any direct indication by the user. Such rules, logic and algorithms may evaluate the social profile of the user, the browsing history of the user, calendars, previous indications made by the user and so on. For instance, the system may integrate with the calendar or social profile of the user to collect information suggesting that the planned trip is a business trip; the system may then adjust the likelihood of the relevance of in-room internet usage accordingly. Fees supported by the system may include, among others: resort fees, facilities fees, parking fees, taxes and government charges, internet fees, room-service fees, security deposits, in-room entertainment fees, refrigerator fees, roll-away bed fees, cleaning fees, and the like. Discounts supported by the system may include, among others: senior discounts, military discounts, AAA discounts, travel agency discounts, government discounts, loyalty discounts and the like. The system may enable travelers, hoteliers and other sellers of travel to visualize the distribution of fees across rentable units using charts, graphs and the like.

The system may also support alerts to advise travelers when fees have changed with regard to a trip that has been booked or planned but not completed. Such alerts may be implemented by storing the fees pertinent to a user along with any actual or contemplated itinerary applicable to the user within a user profile in a database. For instance, if a user had booked a stay at Hotel X and had indicated that the pet fee was relevant, then if the pet fee at Hotel X changed between the time the user booked the trip and the time that the trip was completed, the system may generate an alert advising the user of the revised cost associated with bringing a pet. This alert may prompt the user to cancel his reservation and book at another hotel that has now become a better deal in light of the fee change. The system may also facilitate communication between travelers, hotels and other sellers of travel to keep travelers apprised of actual or planned changes to fees and/or discounts.

In one example of the Suite-Splitter, a computer implemented method of dynamically allocating costs of a rentable unit across two or more users includes the steps of: assigning two or more users to an event; assigning a date range to the event; assigning a rentable unit to the event, wherein the rentable unit includes a two or more assets and a total price for the assigned date range; and receiving an initial bid for an asset from each user; allocating a preliminary asset and a preliminary sub-total to one or more users based on the initial bids received, wherein the sum of the allocated preliminary sub-totals does not necessarily equal the total price of the rentable unit for the assigned date range; and offsetting any difference between the sum of the allocated preliminary sub-totals and the total price of the rentable unit for the assigned date range by allocating a final sub-total to each of the two or more users, wherein the sum of the allocated final sub-totals equals the total price of the rentable unit for the assigned date range.

The method may further include the step of: each user executing payment of the user's allocated final sub-total through an online payment mechanism that consolidates the two or more user's executed payments into a single payment equivalent to the total price. The single payment equivalent to the total price may be transferred to a party renting the rentable unit.

The method of may further include the step of dynamically adjusting either the preliminary sub-totals or the final sub-totals in response to receiving a second bid from a user.

The initial bid for an asset from each user may include a joint bid associated with at least two users. Preference to one or more assets may be given to a joint bid from users that are designated as in a relationship.

The rentable unit may be one or more hotel rooms and the two or more assets may be two or more heterogeneous sleeping areas within the one or more hotel rooms.

The method may further include the step of storing and analyzing the final sub-totals in order to over time determine normal or fair price divisions for the rentable unit. The stored and analyzed final sub-totals may be accessible to a user responsible for renting the rentable unit.

The method may further include the step of providing a visual display of the allocation of the assets.

In another example, a computer implemented method of allocating costs of a rentable unit across two or more users includes the steps of: assigning two or more users to an event; assigning a date range to the event; assigning a rentable unit to the event, wherein the rentable unit includes two or more heterogeneous sleeping areas and a total price for the assigned date range; assigning a sleeping area to each of the users; and allocating a sub-total to each of the users based on relative value of the assigned heterogeneous sleeping area, wherein the sum of the allocated sub-totals equals the total price of the rentable unit for the assigned date range.

The relative value of the heterogeneous sleeping areas may be determined relative to the square footage associated with the heterogeneous sleeping areas. The relative value of the heterogeneous sleeping areas may be determined relative to the amenities associated with the heterogeneous sleeping areas. The relative value of the heterogeneous sleeping areas is determined by an auction amongst the two or more users.

The auction may include the steps of: receiving a bid for one of the heterogeneous sleeping areas from each user; allocating a preliminary sub-total to one or more users based on the bids received, wherein the sum of the allocated preliminary sub-totals does not necessarily equal the total price of the rentable unit for the assigned date range; and offsetting any difference between the sum of the allocated preliminary sub-totals and the total price of the rentable unit for the assigned date range by allocating a final sub-total to each of the two or more users, wherein the sum of the allocated final sub-totals equals the total price of the rentable unit for the assigned date range.

The step of allocating a sub-total to one or more users may include allocating a sub-total on a first to pay basis. The steps of assigning a sleeping area to each of the users and allocating a sub-total to each of the users based on relative value of the assigned heterogeneous sleeping area may occur simultaneously. The step of assigning a sleeping area to each of the users may be based on voting by the users.

In another example, a system includes: a controller; a memory coupled to the controller, wherein the memory is configured to store program instructions executable by the controller; wherein, in response to executing the program instructions, the controller is configured to: assigning two or more users to an event; assigning a date range to the event; assigning a rentable unit to the event, wherein the rentable unit includes two or more heterogeneous sleeping areas and a total price for the assigned date range; assigning a sleeping area to each of the users; and allocating a sub-total to each of the users based on relative value of the assigned heterogeneous sleeping area, wherein the sum of the allocated sub-totals equals the total price of the rentable unit for the assigned date range.

The relative value of the heterogeneous sleeping areas may be determined by an auction amongst the two or more users, the auction including the steps of: receiving a bid for one of the heterogeneous sleeping areas from each user; allocating a preliminary sub-total to one or more users based on the bids received, wherein the sum of the allocated preliminary sub-totals does not necessarily equal the total price of the rentable unit for the assigned date range; and offsetting the difference between the sum of the allocated preliminary sub-totals and the total price of the rentable unit for the assigned date range by allocating a final sub-total to each of the two or more users, wherein the sum of the allocated final sub-totals equals the total price of the rentable unit for the assigned date range.

An advantage of the Suite-Splitter system is that it allows travelers splitting hotel accommodations to find a typical, market clearing, or otherwise equitable price for each sleeping area within a rentable unit.

Another advantage of the Suite-Splitter system is that it allows travelers to track, divide and re-divide the price of a rentable unit in real time.

An additional advantage of the Suite-Splitter system is that it allows travelers to visualize the assignment of travelers to sleeping areas using charts, floor plans and other diagrams.

A further advantage of the Suite-Splitter system is that it provides a forum for travelers to negotiate the assignment of sleeping areas and the allocation of price with full information on a level playing field.

Yet another advantage of the Suite-Splitter system is that it provides for efficient payment processing and tracking among multiple travelers sharing the cost of a rentable unit.

Still another advantage of the Suite-Splitter system is that it allows hoteliers to provide targeted and actionable communications to individuals connected in a network who might be interested in staying together in a rentable unit of a hotel.

An advantage of the room-class matching system is that it facilitates comparison-shopping across multiple inventory sources.

Another advantage of the room-class matching system is that it facilitates deal identification based on observable characteristics of room-classes, such as historical price and amenities.

A further advantage of the room-class matching system is that it promotes compliance with pricing policies contained in contractual agreements and reduces the cost of monitoring those agreements.

Still another advantage of the room-class matching system is that various components of the system may be automated, while other components may be manually executed, and the proportion of automated to manual processes may be varied to suit a particular application.

An advantage of the rentable unit analysis system is that it facilitates translation of room descriptions and non-standardized data into variable values suitable for quantitative analysis.

A further advantage of the rentable unit analysis system is that it facilitates efficient evaluation of aggregate price-levels within market segments.

Another advantage of the rentable unit analysis system is that it facilitates efficient and accurate assessment of the quality of rentable units.

Yet another advantage of the rentable unit analysis system is that it facilitates efficient and accurate evaluation of the prices and refund policies associated with rentable units.

Yet another advantage of the rentable unit analysis system is that it enables travelers to interact with data, analysis and conclusions to facilitate more efficient search.

A further advantage of the rentable unit analysis system is that it improves revenue management systems by enabling hoteliers and travel agents to efficiently compare rentable units with substitute units.

A further advantage of the rentable unit analysis system is that it facilitates an opaque booking platform for suites and other rooms with non-standard features.

An advantage of the Attribute Utility Optimization System is that it allows a traveler to efficiently and precisely compare large numbers of rentable units and amenities based on the traveler's individual preferences.

Another advantage of the Attribute Utility Optimization System is that it allows a traveler to rationally evaluate whether a room is a deal at a given price in light of the utility the traveler or group of travelers expects to derive from various attributes associated with the rentable unit.

An additional advantage of the system is that it can alert a traveler of opportunities to purchase a rentable unit for a price that is attractive compared to the subjective value that the traveler assigns to the attributes of the rentable unit.

Another advantage of the Attribute Utility Optimization System is that it allows hoteliers and travel agents to collect, organize, and analyze granular data about preferences of travelers.

A further advantage of the system is that it allows hoteliers and travel agents to identify market-clearing prices for rentable units.

Yet another advantage of the Attribute Utility Optimization System is that it allows a traveler to place bids in an opaque bidding system based upon the traveler's preference for amenities of rentable units.

An advantage of the single-action deal-identification system is that it significantly reduces the time that travelers searching for accommodations must spend evaluating the characteristics of those accommodations.

A related advantage of the system is that it significantly reduces the number of interactions between the client computer and the server computer, which reduces overhead costs.

An advantage of the deal-measurement system is that it allows travelers to efficiently compare fees and discounts on a standardized basis.

Another advantage of the deal-measurement system is that it allows travelers to efficiently evaluate rentable units after incorporating pertinent fees.

A further advantage of the system is that it substantially reduces the number of interactions between client computers and server computers.

A further advantage of the deal-measurement system is that it enables hoteliers and other sellers of travel to determine which fees are relevant to which users.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of an example of the Suite-Splitter system demonstrating the flow of information between the various elements of the system.

FIG. 2 is a conceptual illustration of the various functions that may be provided by a Suite-Splitter system.

FIG. 3A is a flowchart illustrating an example of a method of organizing, managing, and financing a trip among friends using the Suite-Splitter system.

FIG. 3B is a flowchart illustrating additional details of an example of a method of organizing, managing, and financing a trip among friends using the Suite-Splitter system.

FIG. 3C is a flowchart illustrating additional details of an example of a method of organizing, managing, and financing a trip among friends using the Suite-Splitter system.

FIG. 4 is a flowchart illustrating an example of a method of allocating beds and costs to participants in a trip using a modified auction process facilitated by the Suite-Splitter system.

FIG. 5 is a schematic representation of an example of the room-type classification system demonstrating the flow of information between the various elements of the system.

FIG. 6 is a flowchart illustrating an example of a method of associating room-classes with data received from an external data source.

FIG. 7 is a schematic representation of an example of the rentable-unit analysis system demonstrating the flow of information between the various elements of the system.

FIG. 8 is a conceptual illustration of various functional components that may be provided by a rentable-unit analysis system.

FIG. 9 is a schematic representation of an example of the attribute utility optimization system demonstrating the flow of information between the various elements of the system.

FIG. 10 is a schematic representation of an example of the single-action deal-classification system demonstrating the flow of information between the various elements of the system.

FIG. 11 is a schematic representation of an example of the price-analysis system with discretionary incorporation of fees and discounts, demonstrating the flow of information between the various elements of the system.

FIG. 12 is an example of a screenshot of a map display including hotel details.

FIG. 13 is an example of a screenshot showing an amenity histogram.

FIG. 14 is an example of a screenshot showing a stratified search result.

FIG. 15 is an example of a screenshot showing a Suite Score.

FIG. 16 is an example of a screenshot showing a Fair Value.

### DETAILED DESCRIPTION OF THE INVENTION

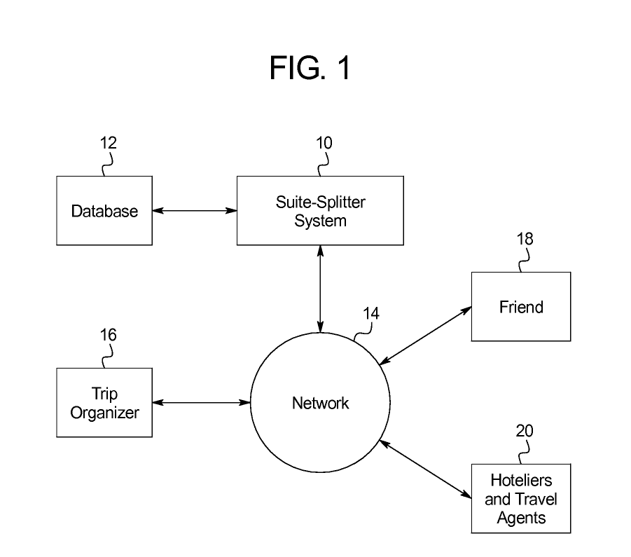

FIG. 1 illustrates an example of a Suite-Splitter system 10 and the related elements. As shown in FIG. 1, the Suite-Splitter system 10 may be in communication with a database 12 and a network 14. As shown, the Suite-Splitter system 10 is in direct communication with the database 12. Of course, in other embodiments, the Suite-Splitter system 10 may be in communication with the database through the network 14. While shown and described as a database 12, it is understood that the database 12 may be any number of databases 12 adapted to support the necessary data management for the various features and functions of the Suite-Splitter system 10 described herein. It is further contemplated that a database 12, as understood in the traditional sense, may not be a requirement of the Suite-Splitter system 10 described herein, and that any other mechanism or mode of data management may be employed.

As further shown in FIG. 1, one or more trip organizers 16 may interact with the Suite-Splitter system 10 and one or more friends 18 through the network 14. Communication through the network 14 enables the Suite-Splitter system 10 to provide an interactive website and/or mobile application through which one or more trip organizer 16 and friends 18 may share information. Networked communication further enables the Suite-Splitter system 10 to facilitate the sharing of information on social networking websites such as Facebook, Twitter, or any other social network. As is described in further detail below, the Suite-Splitter system 10 improves the efficiency with which trip organizers 16 and friends 18 communicate with each other, receive communications from hoteliers and travel agents 18, visualize and allocate areas to sleep, allocate price, and collect payments from each other or pay together.

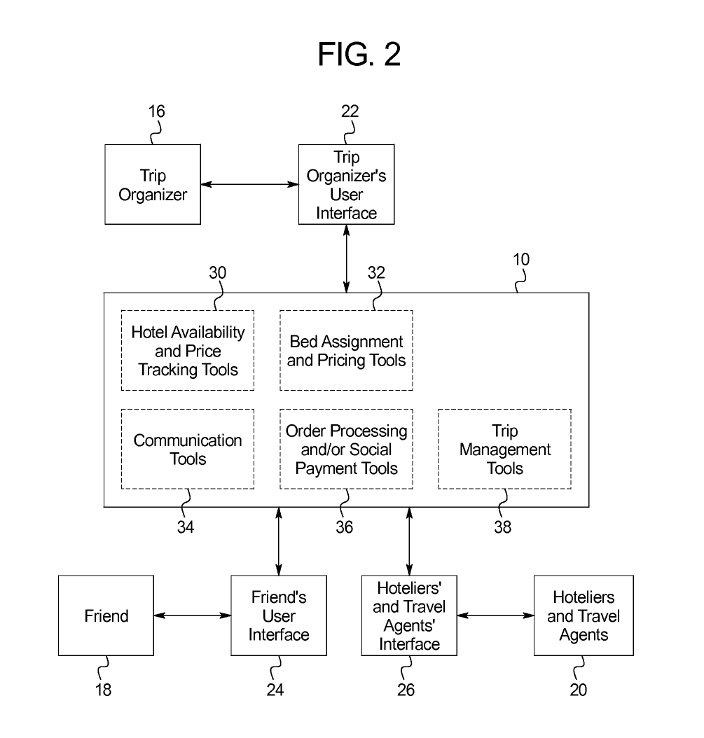

FIG. 2 illustrates various functions that may be provided by a Suite-Splitter system 10. For example, as shown in FIG. 2, the Suite-Splitter system 10 may provide hotel availability and price tracking tools 30, bed assignment and pricing tools 32, communication tools 34, order processing and/or social payment tools 36, and trip management tools 38. While the embodiment of the Suite-Splitter system 10 shown in FIG. 2 is the presently preferred embodiment, it is contemplated that various versions of the Suite-Splitter system 10 may include a greater or lesser number of management tools and will be apparent to those skilled in the art based on the disclosure provided herein.

In the example provided in FIG. 2, a trip organizer 16 is shown accessing the Suite Splitter system 10 through a trip organizer's user interface 22. In the example shown, the trip organizer's user interface 22 may be a provided via a personal computer, mobile application residing on a smartphone, or any network-enabled device. Additionally, a friend 18 may access the Suite-Splitter system 10 through a similar user interface 24. Again, such user interfaces 24 may be provided in mobile applications, through one or more websites, or in any other networked application or communication protocol. Such friend's user interface 24 may differ in various ways from trip organizer's user interface 22, such as by disabling certain functionality for friend 18 that is enabled for trip organizer 16.

The hotel availability and price tracking tools 30 may be used to reserve hotel rooms through an online interface that facilitates booking. The hotel availability and price tracking tools 30 may send real-time updates to user interface 22 and user interface 24 so that trip organizers 16 and friends 18 may view the available hotel rooms and associated prices at that particular moment. Trip organizers 16 and/or friends 18 may view information about available hotel rooms, may select hotel rooms individually or in the aggregate (such as by voting), and may reserve hotel rooms using an online shopping cart. Trip organizers 16 and/or friends 18 may also view information related to the fairness of the price of one or more hotel rooms in relation to one or more other hotel rooms. Using these tools, trip organizers 16 and/or friends 18 may efficiently choose hotel rooms and dates for their trip.

The hotel availability and price tracking tools 30 may allow trip organizers 16 and friends 18 to apply automated hotel room selection and booking rules. For example, to quash arguments among the trip participants, a trip organizer 18 may be provided with an automated tool that selects and books the best room (based on user input, expert input, price, deal quality, or other factors) that accommodates a minimum number of guests. Of course, other rules will become obvious to anyone familiar with the Suite-Splitter system.

To determine the assignment of trip participants to beds, as well as the allocation of costs to participants, trip organizers 16 and/or friends 18 may want information about the bedding layout(s) associated with a particular suite, tools for equitably assigning trip participants to beds, and tools for determining the fair price of each bed. Trip organizers 16 and friends 18 currently use crude methods of allocating beds, such as allocating a bed to the first person to put his/her suitcase on it. Furthermore, when bed choices differ meaningfully in quality, such as when the choice is between a king bed in the master bedroom and a sofa bed in the living room, fairness suggests that participants should each pay a price commensurate with the quality of his/her bedding situation. Currently, trip participants either suffer the injustice of allowing all participants to pay an equal price irrespective of bedding situation, or trip participants bicker endlessly about what constitutes a fair division of price. This leads to animosity between participants in a group trip, which can undermine the collegial purpose of the trip. Accordingly, the bed assignment and pricing tools 32 shown in FIG. 2 may be provided to improve the system of allocating beds and costs among trip participants. For example, the bed assignment and pricing tools 32 of the Suite-Splitter system 10 may facilitate a modified auction to determine the fair price and allocation of beds, either in continuous real-time or at discrete intervals. Moreover, the bed assignment and pricing tools 32 may use the results of prior auctions to suggest fair prices to future users booking the same suite. Of course, bed assignment and pricing tools 32 may provide numerous tools for the access, compilation, and communication of bedding and pricing data between all users of the Suite-Splitter system 10.

In a further example, bed assignment and pricing tools 32 of the Suite-Splitter system 10 may track real-time prices of suites that are being considered but have not yet been booked to facilitate the dynamic division of such prices amongst trip participants. Because travel prices continuously change, such functionality is useful in allowing groups to jointly finance trips prior to booking them. For example, in one embodiment, the bed assignment and pricing tools 32 of the Suite-Splitter system 10 may automatically adjust the price allocated to each trip participant in proportion to changes in the price of the suite that is being split.

In a further example, bed assignment and pricing tools 32 of the Suite-Splitter system 10 may allow the trip organizer 16 and/or friends 18 to incorporate and allocate incidental costs associated with the suite (or the trip more generally), such as room service, hotel fees, parking, internet fees, security deposits and so on. Since the price of staying in a hotel can increase with these incidental costs, trip organizers 16 and friends 18 would naturally benefit by incorporating them into a system of cost allocation.

The Suite-Splitter system 10 may also facilitate communication between trip organizers 16 and/or friends 18 through various communication tools 34. For example, the communication tools 34 may enable organizers 16 to use a centralized platform to communicate through social networks to inform friends 18 of trips and itinerary, as well as receive feedback about proposed suites and the allocation of costs. This allows trip organizers 16 and/or friends 18 to be in constant communication. Open and constant communication is useful because group trips are often scheduled at the last minute, which makes dispersed and disorganized communication impractical. Of course the provided communication tools 34 may enable communication between any of the users in various forms, such as email messaging, instant messaging, text messaging, message boards and forums, video conference, etc.

The communication tools 34 of the Suite-Splitter system 10 may also facilitate communication between hoteliers and travel agents 20 and trip participants (including trip organizers 16 and friends 18). Trip participants may have specific questions or requirements that necessitate personal care from hoteliers and travel agents 20. Additionally, hoteliers and travel agents 20 may find the Suite-Splitter system to be a useful channel for offering deals and other promotions to travelers seeking to jointly finance trips.

The Suite-Splitter system 10 may also support Internet-based order processing and social payment tools 36 to facilitate booking suites and/or processing repayments between trip participants. For example, a trip organizer 16 and/or friends 18 may access the Suite-Splitter system 10 to view hotel pricing and availability for the purpose of booking a suite and splitting it. Using order processing and social payment tools 36, the trip organizer 16 may pay hotelier 20 to reserve the suite and then manage remittances from friends 18. Alternatively or in addition, the trip organizer 16 and friends 18 may pay hotelier 20 to reserve the suite together via separate individual payments to the hotelier that are coordinated (e.g., identified as all pertaining to a particular trip and assigned to trip participants) by the order processing and social payment tools 36 of the Suite-Splitter system 10.

Finally as shown in FIG. 2, the Suite-Splitter system 10 may also facilitate coordinated production and sharing of schedules or itineraries, review writing, and media sharing using the trip management tools 38 of the Suite-Splitter system 10. Trip organizers 16 and friends 18 partaking in a group trip can plan and execute their trips more efficiently if schedules/itineraries are shared in a centralized and coordinated manner. Toward that end, trip management tools 38 may receive schedules or itinerary from trip organizers 16 and friends 18, distribute schedules or itinerary to trip organizers 16 and friends 18, and store schedules or itinerary. Moreover, trip management tools 38 may include automated routines for retrieving schedules from various calendar applications (e.g., Google Calendar), or itineraries from hoteliers and travel agents 20 or specific external applications specializing in itinerary management. Further, trip management tools 38 may include logic for discovering dates that are most convenient for trip organizers 16 and/or friends 18 on the basis of their schedules, or logic for discovering events based on preferences of trip participants that are occurring on particular dates and that do not conflict with existing itinerary. Trip organizers 16 and friends 18 naturally desire to share their experiences relating to a group trip through review writing, image posting, video posting, and various other forms of media. Currently, such sharing is largely scattered and uncoordinated across social media platforms and, within each social media platforms, scattered across user accounts. The trip management tools 36 of the Suite-Splitter system 10 may facilitate sharing of reviews and media that is more efficient, more searchable, and more meaningful by allowing reviews and media to be shared across all social media platforms simultaneously and associated with all trip participants on each platform. For example, a photo posted by one user in the Suite-Splitter system may automatically be shared across platforms such as facebook.com and flickr.com in an album that is automatically dated and labeled based on the name and date of the trip, and may also automatically tag all trip participants in the photo.

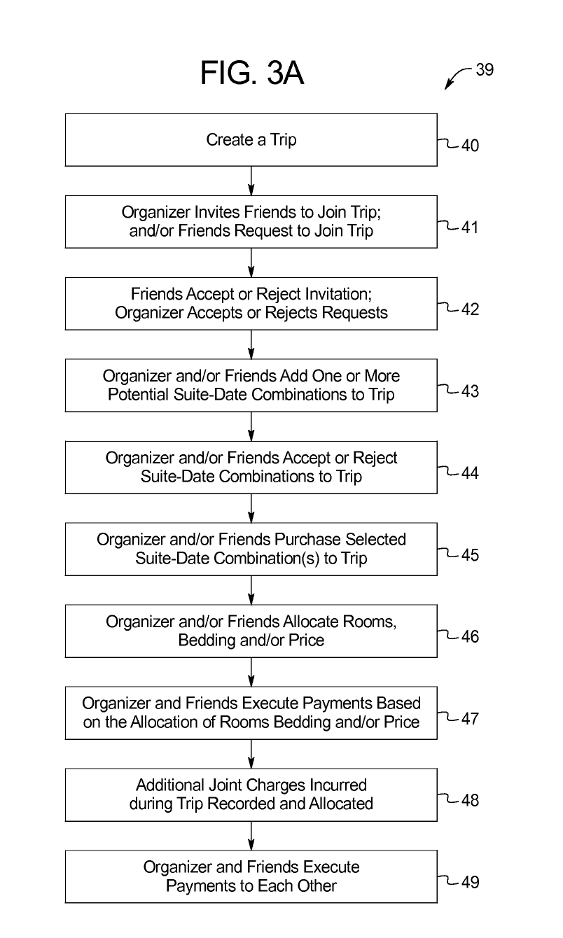

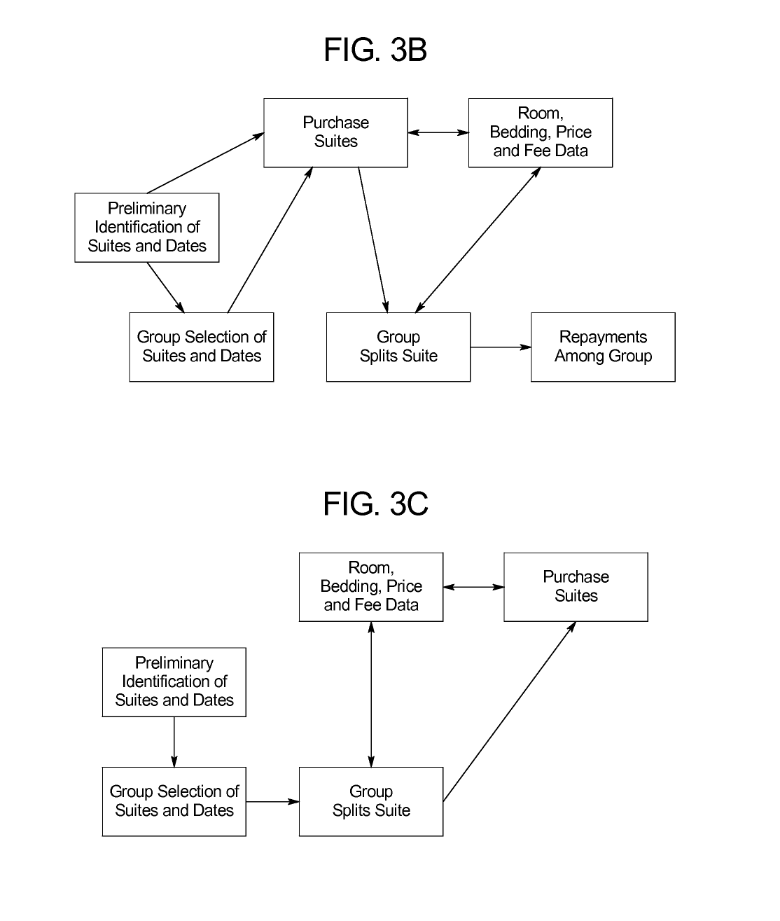

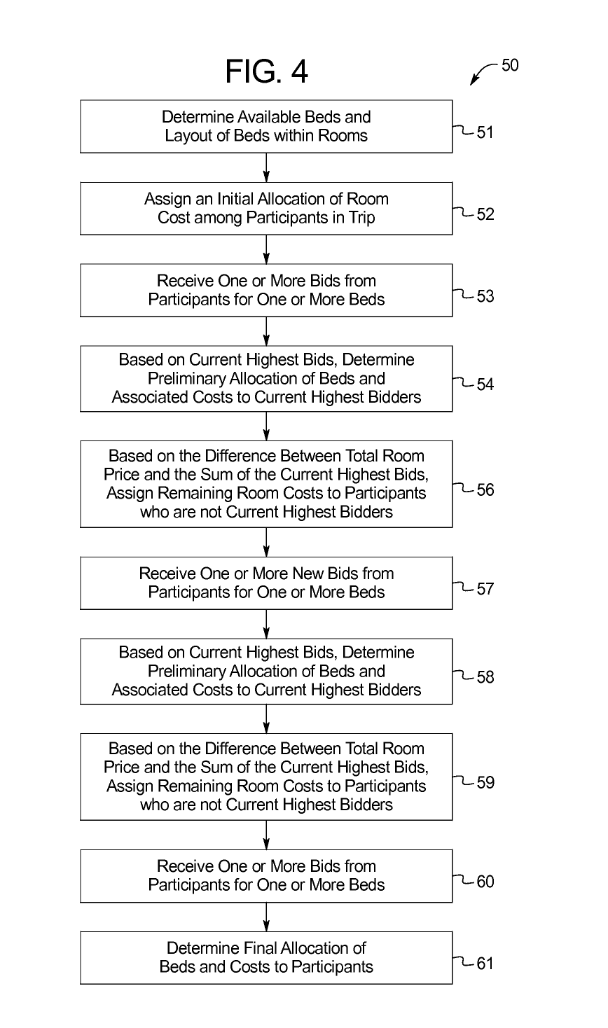

FIGS. 3 and 4, described in further detail below, expand on the concepts described with respect to FIG. 2 by providing additional detailed examples. It is understood that the Suite-Splitter system 10 may be implemented to provide a wealth of tools and services and that these examples are not limitations on the numerous uses of the Suite-Splitter system 10.

As discussed above, trip organizers 16 and friends 18 may use the Suite-Splitter system 10 to plan, manage and finance a group trip in a coordinated, fair and efficient fashion. One example of such a method 39 is provided in FIG. 3A.

As shown in FIG. 3A, the first step 40 of the method 39 is creating a trip. The second step 41 is for the trip organizer 16 to invite friends 18 to join a trip, or for friends 18 to request that the trip organizer 16 add them to the trip. The third step 42 is for friends 18 to accept or reject invitations from trip organizers 16, and for trip organizers 16 to accept or reject requests from friends 16. The system 10 may contain automated rules for accepting or rejecting requests from certain friends 18 or trip organizers 16, or for only sending invitations and requests to certain friends 18 and trip organizers 16 but not others. The fourth step 43 is for trip organizer 16 and/or friends 18 to add potential suite-date combinations to the trip. For instance, a trip organizer 16 may add “Salon Suite” at “Encore Resort” in “Las Vegas, Nev.” on “Jun. 25, 2012 to Jun. 26, 2012” as a potential suite-date combination of the trip. Of course, although step 43 is depicted as occurring after friends 18 have been added to the trip, in practice this step will frequently be seen to occur before one or more friends 18 have been added to the trip. In the next step 44, trip organizers 16 and/or friends 18 can accept or reject potential suite-date combinations. The system 10 may provide decision-making tools to facilitate the selection of a suite date-combination, such as voting tools, or automated deal comparison tools. Of course, in practice this step 44 may occur before one or more friends 18 have been added to the trip. Once one or more suite-date combinations have been chosen, trip organizer 16 and/or friends 18 may have the opportunity to book the chosen suite-date combinations in step 45 using Internet-based order processing and/or social payment tools 36 as described above. In step 46, trip organizers 16 and/or friends 18 allocate rooms, bedding and/or the cost of the trip using bed assignment and pricing tools 32 described above. For instance, a group of travelers splitting the “Salon Suite” at “Encore Resort” can determine who will sleep in the king bed and who is relegated to sleeping on sofas or the floor, as well as the percentage of the total cost to allocate to each traveler. The system 10 may provide automated methods for determining a market-clearing price of each bed based on supply and demand, or may facilitate a modified auction as detailed in FIG. 4. Of course, other allocation techniques including randomization and voting are also likely. It should be noted that although step 46 is shown as occurring after a suite has been booked, frequently step 46 will occur before a suite has been booked, as trip organizers 16 and friends 18 may use this aspect of the system 10 to gauge interest in a trip or to gauge the group's collective ability to finance a trip prior to booking it. In step 47, trip organizers 16 and friends 18 utilize order processing and/or social payment tools 36 to pay each other or to pay hoteliers and travel agents 20 consistent with the cost allocation determined in step 46. In step 48, additional charges are incurred during the trip, recorded by the system, and allocated among trip organizer 16 and/or friends 18. Such division may follow the same rules employed to divide the initial cost of the trip, or may follow a new set of rules. Step 49 concludes the process as the trip organizer 16 and/or friends 18 utilize order processing and/or social payment tools 36 to settle their accounts.

FIG. 3B and FIG. 3C illustrate two potential sequences of events related to the implementation example illustrated by FIG. 3A. In FIG. 3B suites are purchased before being split; in FIG. 3C suites are purchased after being split.

FIG. 4 offers a more nuanced depiction of the steps involved in one example of a modified auction system utilized by trip organizers 16 and friends 18 to simultaneously allocate beds and allocate the costs of a trip within the Suite-Splitter 10. The modified auction system described below contains unique aspects to address the unique problems faced by individuals seeking to split the costs of a suite—namely, that the prices paid for various subdivisions of the suite must sum to the exogenously determined price of the suite. FIG. 4 depicts an example implementation of such an auction system in the context of simultaneously assigning beds in a suite to travelers and allocating cost among travelers, as part of the bed assignment and pricing tools 32 within the Suite-Splitter system 10. A number of complex algorithms could be employed toward this end and will be apparent to those with normal skill who have read the disclosures herein. The example depicted is intentionally simple for the sake of clarity.

As shown in FIG. 4, the first step 51 of the method 50 is to determine the available beds in a suite and the layout of those beds within rooms. Once the available bedding options have been determined, an initial allocation of costs may be assigned to trip participants in step 52. For instance, before any bids have been placed, the system may divide costs equally among all trip participants so that the suite is fully funded prior to any bidding. In step 53, the system receives bids for specific beds from one or more trip participants. In step 54, the system uses the bids received in step 53 to reach a preliminary assignment of bidders to beds and allocation of costs to bidders. For example, step 54 could assign each bed to its highest bidder, and allocate a cost to each highest bidder equal to his bid. Step 56 addresses the problem that the sum of the prices paid by individuals must at all times equal the total price of the suite for the transaction to be feasible. In step 56, feasibility is achieved by reducing (increasing) the price paid by individuals who are not assigned to any bed dollar-for-dollar with the surplus (deficit) of (i) the sum of individual prices above (below) (ii) the market price of the suite as a whole. Of course, it will be apparent to those who have read the methods disclosed herein that any number of other techniques could be used to offset the surplus (deficit). Steps 57 through 61 repeat the above-described steps until a pre-defined or dynamically determined end of the auction is reached. Of course, in practice the auction method 50 could actually consist of a single round, or multiple rounds, or could simply transpire in continuous time and thus not exhibit anything resembling discrete rounds.

In another example, an hotelier 20 or other entity responsible for setting the price for a rentable unit may have a reservation price that is not revealed to the trip organizers 16 and friends 18. The bids are received and collectively accepted only when they exceed the reservation price. In such a system, the hotelier 20 or other entity responsible for setting the price for a rentable unit may make the unit available at auction, but guarantee that the auctioned rate is never below a predetermined threshold.

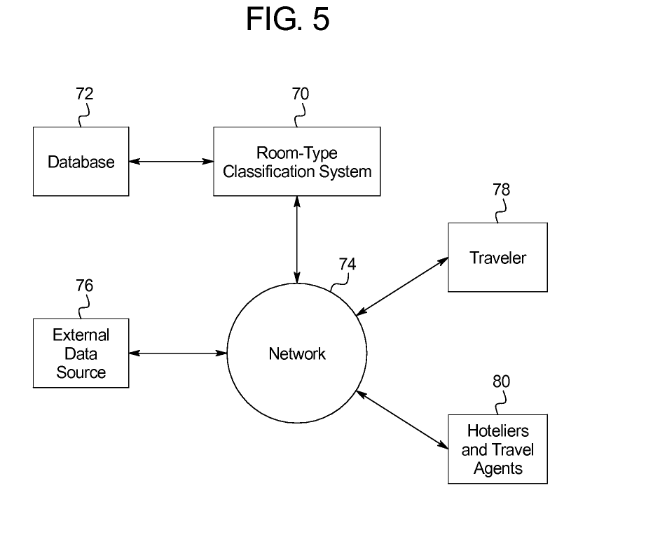

FIG. 5 illustrates an example of a room-type classification system 70 and the related elements. As shown in FIG. 5, the room-type classification system 70 may be in communication with a database 72 and a network 74. As shown, the room-type classification system 70 is in direct communication with the database 72. Of course, in other embodiments, the room-type classification system 70 may be in communication with the database through the network 74. While shown and described as a database 72, it is understood that the database 72 may be any number of databases 72 adapted to support the necessary data management for the various features and functions of the system 70 described herein. It is further contemplated that a database 72, as understood in the traditional sense, may not be a requirement of the system 70 described herein, and that any other mechanism or mode of data management may be employed.

As further shown in FIG. 5, one or more travelers 78 may interact with the system 70 through the network 74. Communication through the network 74 enables the system 70 to provide an interactive website and/or mobile application. Networked communication further enables the system 70 to facilitate the sharing of information on social networking websites such as Facebook, Twitter, or any other social network.

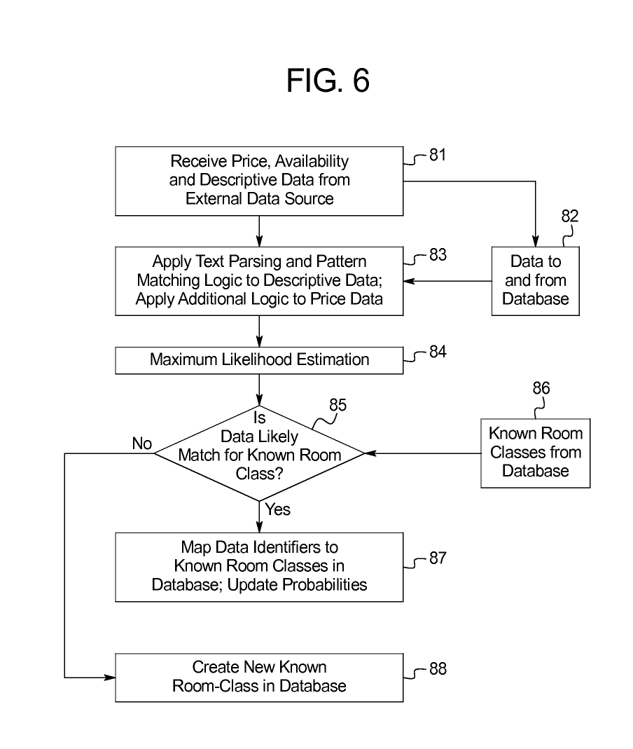

FIG. 6 provides further detail with respect to one possible sequence of events in an example implementation of the room-type classification system. Of course, this is meant to illustrate a simplified implementation, not to limit the many possible implementations that will be apparent to those familiar with the system. In step 81, the system 70 receives data over a network 74 from an external data source 76. In step 82, the system stores the received data in a database, and transmits data to subsequent steps for processing. In step 83, text parsing and pattern-matching algorithms are initiated to standardize and interpret the data. In particular, algorithms may be applied to names and descriptions received from an external data source in search of one or more patterns that are recognized by the database as correlating with a room-class. In step 84, statistics are applied to pattern frequencies identified in step 83 to evaluate the likelihood that the data corresponds to a known room-class in the database. In steps 85 through 88, one of two paths is followed depending on whether the likelihood that the data corresponds to a known room-class exceeds a threshold: if the likelihood of a room-class match exceeds the threshold, then in step 87 identifiers in the data are mapped to known room classes in the database, and the database may be further updated to reflect the new probabilities that the room-class exhibits certain patterns given the patterns of the new data that has just been mapped to the room-class; if the likelihood of a room-class match fails to exceed the threshold, then in step 88 a new room-class is created in the database and the data received from an external source is associated with that room-class.

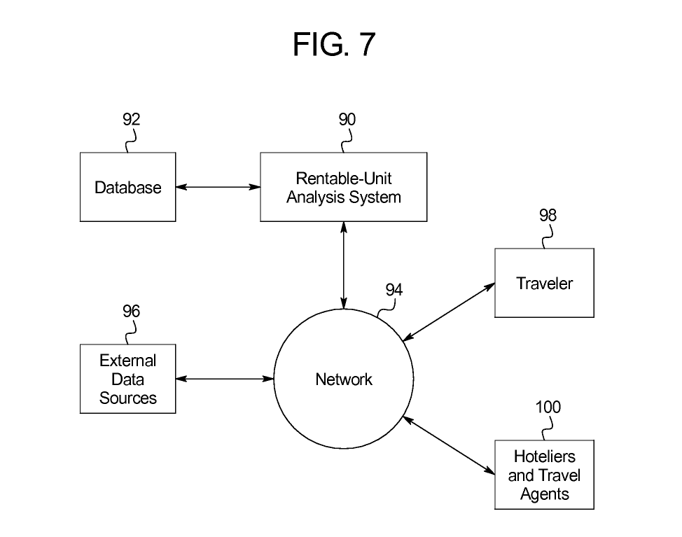

FIG. 7 illustrates an example of a rentable-unit analysis system 90 and the related elements. As shown in FIG. 7, the rentable-unit analysis system 90 may be in communication with a database 92 and a network 94. As shown, the rentable-unit analysis system 90 is in direct communication with the database 92. Of course, in other embodiments, the room-type classification system 90 may be in communication with the database through the network 94. While shown and described as a database 92, it is understood that the database 92 may be any number of databases 92 adapted to support the necessary data management for the various features and functions of the system 90 described herein. It is further contemplated that a database 92, as understood in the traditional sense, may not be a requirement of the system 90 described herein, and that any other mechanism or mode of data management may be employed.

As further shown in FIG. 7, one or more travelers 98 may interact with the system 90 through the network 94. Communication through the network 94 enables the system 90 to provide an interactive website and/or mobile application. Networked communication further enables the system 90 to facilitate the sharing of information on social networking websites such as Facebook, Twitter, or any other social network. Furthermore, establishing networked connection with external data sources 96 enables the system 90 to receive real-time prices, availability, descriptions and other data that are analyzed by the system 90. Hoteliers and travel agents 100 may interact with the system 90 through the network 94. Networked communication enables hoteliers and travel agents 100 to utilize the system for a variety of purposes, including revenue management. Of course, although hoteliers and travel agents 100 are depicted separately from external data sources 96, hoteliers and travel agents 100 may also constitute important data sources 96.

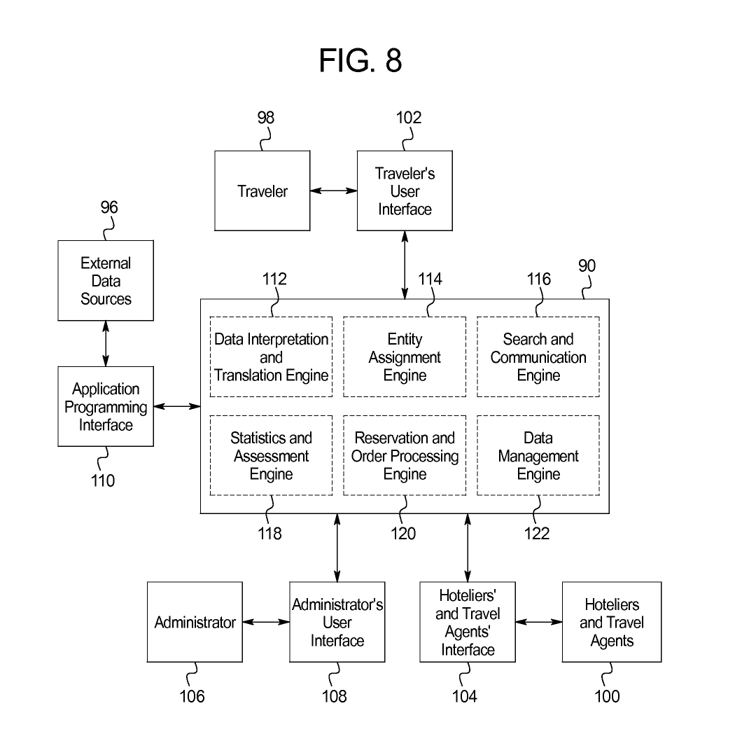

FIG. 8 illustrates various functional components that may be provided by a rentable-unit analysis system 90. For example, as shown in FIG. 8, the system 10 may provide a data interpretation and translation engine 112; entity assignment engine 114; search and communication engine 116; statistics, assessment & prediction engine 118; reservation & order processing engine 120; and data management engine 122. While the embodiment of the system 90 shown in FIG. 8 is the presently preferred embodiment, it is contemplated that various versions of the system 90 may include a greater or lesser number of functionalities and will be apparent to those skilled in the art based on the disclosure provided herein.

In the example provided in FIG. 8, a prospective traveler 98 is shown accessing the system 90 through a traveler's user interface 102. In the example shown, the traveler's user interface 102 may be a provided via a personal computer, mobile application residing on a smartphone, or any network-enabled device. Additionally, hoteliers and travel agents 100 may access the system 90 through a user interface 104. Again, such user interfaces 104 may be provided in mobile applications, through one or more websites, or in any other networked application or communication protocol.

The data interpretation and translation engine 112 may be used to process data received from external data sources 96 before subjecting such data to statistical analysis. The data interpretation and translation engine 112 may utilize logic to standardize and/or quantify information that is qualitative, not standardized or non-numeric when received by the system 90 from external data sources 96. The entity assignment engine 114 facilitates mapping data received from external data sources 96 with known entities in system 90. For instance, the entity assignment engine 114 may support pattern matching and statistics to assign known room classes to data received from external data sources 96.

The search and communication engine 116 enables a variety of interactions with travelers 98, external data sources 96, and hoteliers and travel agents 100. For instance, the search and communication engine 116 may facilitate queries over a network for room prices, availability, descriptive information, assessments, media and other data. Such queries may be in response to user commands or may be programmatic and effectuated at fixed intervals. The search and communication engine 116 may operate in real time. Travelers 96 may view information about available hotel rooms, may select hotel rooms, and may request detailed information and analysis about hotel rooms. Travelers 96 may also view assessments related to the price and quality of one or more hotel rooms in relation to one or more other hotel rooms, or one or more market segments in relation to one or more other market segments. The search and communication engine 116 may enable alerts to be sent over a network to any of the several user interfaces 102, 104 and 108. The system 90 may also facilitate communication between travelers 98 and/or hoteliers and travel agents 100 through various communication tools supported by the search and communication engine 116. For example, the communication engine 116 may support a centralized platform to communicate through social networks, as well as receive feedback. This allows travelers 98 and/or hoteliers and travel agents 100 to be in constant communication. Of course the provided communication engine 116 may enable communication between any of the users in various forms, such as email messaging, instant messaging, text messaging, message boards and forums, video conference, etc. The communication engine 116 may also enable hoteliers and travel agents 100 to offer deals and other promotions to travelers 98.

The statistics and assessment engine 118 may support a number of processes directed toward quantifying the quality of rentable units and market segments; modeling the price of rentable units and market segments; and comparing rentable units and market segments. The administrator's user interface 108 may enable administrator's 106 to create or modify rules and logic pertaining to the assessment of rentable units and market segments. In many cases, the inputs to the statistics and assessment engine 118 will be the outputs of the data interpretation and analysis engine 112—in coordination with the entity assignment engine 114, the search and communication engine 116, and the data management engine 122.

The system 90 may also support Internet-based reservation processing and payments engine 120 to facilitate booking rentable units. The reservation and order processing system 120 may enable the traveler 98 to book and pay for rentable units, which may involve networked interaction with inventory distribution services such as those provided by hoteliers and travel agents 100.

Finally as shown in FIG. 7, the system 10 may also facilitate a data management engine 122 to receive, organize, store and serve data to and from the various components of the system 10. Of course, the data management system 122 may support a variety of manual and automated processes, such as caching on client and server machines, to efficiently handle data.

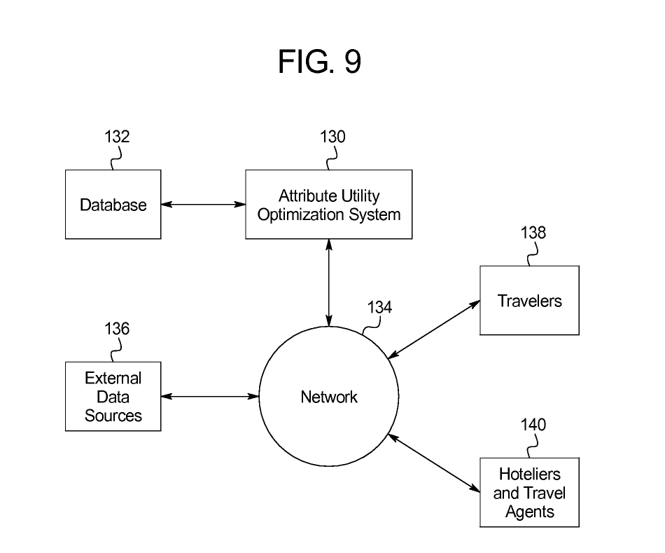

FIG. 9 illustrates an example of an attribute utility optimization system 130 and the related elements. As shown in FIG. 9, the system 130 may be in communication with a database 132 and a network 134. As shown, the system 130 is in direct communication with the database 132. Of course, in other embodiments, the system 130 may be in communication with the database through the network 134. While shown and described as a database 132, it is understood that the database 132 may be any number of databases 132 adapted to support the necessary data management for the various features and functions of the system 130 described herein. It is further contemplated that a database 132, as understood in the traditional sense, may not be a requirement of the system 130 described herein, and that any other mechanism or mode of data management may be employed.

As further shown in FIG. 9, one or more travelers 138 may interact with the system 130 through the network 134. Communication through the network 134 enables the system 130 to provide an interactive website and/or mobile application. Networked communication further enables the system 130 to facilitate the sharing of information on social networking websites such as Facebook, Twitter, or any other social network. Furthermore, establishing networked connection with external data sources 136 enables the system 130 to receive real-time prices, availability, descriptions and other data that are analyzed by the system 130. Hoteliers and travel agents 140 may interact with the system 130 through the network 134. Networked communication enables hoteliers and travel agents 140 to utilize the system for a variety of purposes, including marketing and revenue management. Of course, although hoteliers and travel agents 140 are depicted separately from external data sources 136, hoteliers and travel agents 140 may also constitute important data sources 136.

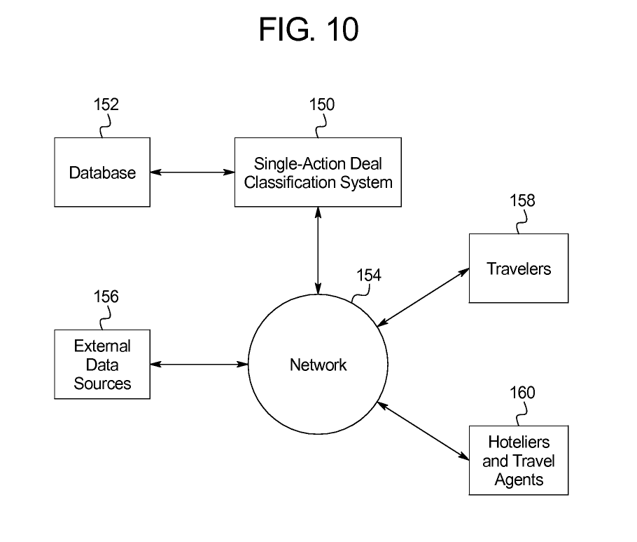

FIG. 10 illustrates an example of a single-action deal classification system 150 and the related elements. As shown in FIG. 10, the system 150 may be in communication with a database 152 and a network 154. As shown, the system 150 is in direct communication with the database 152. Of course, in other embodiments, the system 150 may be in communication with the database through the network 154. While shown and described as a database 152, it is understood that the database 152 may be any number of databases 152 adapted to support the necessary data management for the various features and functions of the system 150 described herein. It is further contemplated that a database 152, as understood in the traditional sense, may not be a requirement of the system 150 described herein, and that any other mechanism or mode of data management may be employed.

As further shown in FIG. 10, one or more travelers 158 may interact with the system 150 through the network 154. Communication through the network 154 enables the system 150 to provide an interactive website and/or mobile application. Networked communication further enables the system 150 to facilitate the sharing of information on social networking websites such as Facebook, Twitter, or any other social network. Furthermore, establishing networked connection with external data sources 156 enables the system 150 to receive real-time prices, availability, descriptions and other data that are analyzed by the system 150. Hoteliers and travel agents 160 may interact with the system 150 through the network 154. Networked communication enables hoteliers and travel agents 160 to utilize the system for a variety of purposes, including marketing and revenue management. Of course, although hoteliers and travel agents 160 are depicted separately from external data sources 156, hoteliers and travel agents 160 may also constitute important data sources 156.

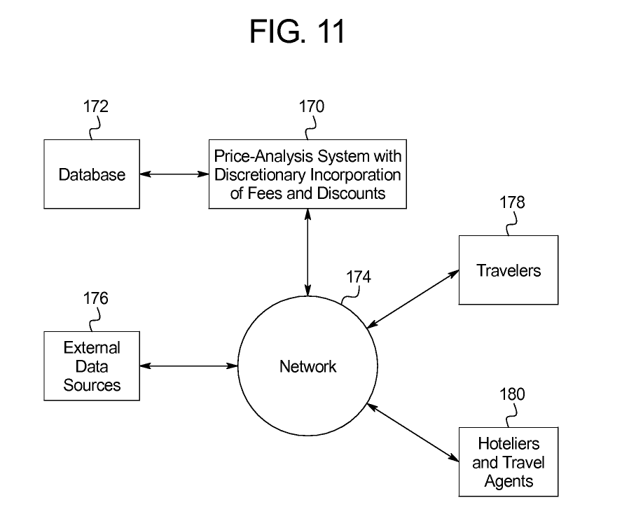

FIG. 11 illustrates an example of the system 170 and the related elements. As shown in FIG. 11, the system 170 may be in communication with a database 172 and a network 174. As shown, the system 170 is in direct communication with the database 172. Of course, in other embodiments, the system 170 may be in communication with the database through the network 174. While shown and described as a database 172, it is understood that the database 172 may be any number of databases 172 adapted to support the necessary data management for the various features and functions of the system 170 described herein. It is further contemplated that a database 172, as understood in the traditional sense, may not be a requirement of the system 170 described herein, and that any other mechanism or mode of data management may be employed.

As further shown in FIG. 11, one or more travelers 178 may interact with the system 170 through the network 174. Communication through the network 174 enables the system 170 to provide an interactive website and/or mobile application. Networked communication further enables the system 170 to facilitate the sharing of information on social networking websites such as Facebook, Twitter, or any other social network. Furthermore, establishing networked connection with external data sources 176 enables the system 170 to receive real-time prices, availability, descriptions and other data that are analyzed by the system 170. Hoteliers and travel agents 180 may interact with the system 170 through the network 174. Networked communication enables hoteliers and travel agents 180 to utilize the system for a variety of purposes, including marketing and revenue management. Of course, although hoteliers and travel agents 180 are depicted separately from external data sources 176, hoteliers and travel agents 180 may also constitute important data sources 176.

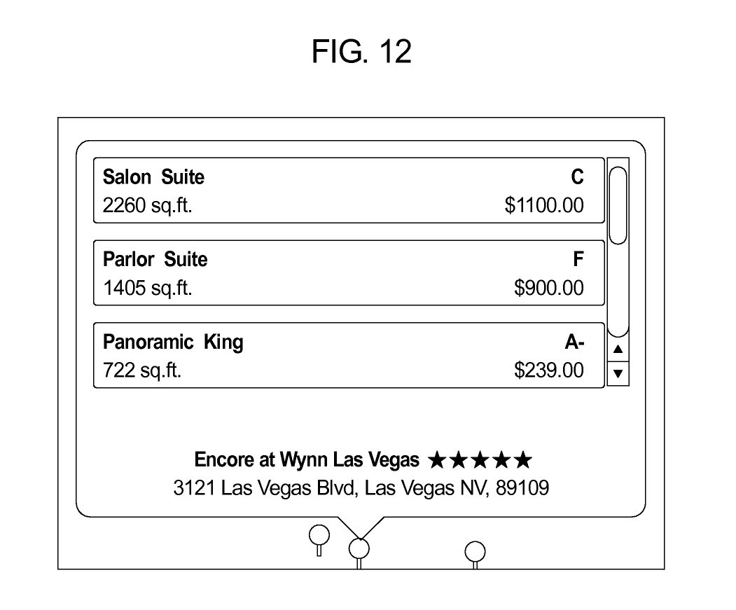

FIG. 12 is an example of a screenshot of a map display including hotel details. In FIG. 12, an indicator is placed on a map to depict the physical location of each hotel. In this embodiment, the relationship between price and model value for each room-class is revealed when the user scrolls over a pin. Room classes are displayed in colored bands, organized with the room class possessing the highest Suite Score at the top and the lowest Suite Score at the bottom, to simulate looking from the penthouse down to the base room class of a hotel. Room-class bands are color coded to depict whether the price of a room is meaningfully above its model value (red), meaningfully below its model value (green), or about the same as its model value (yellow). Of course, in other embodiments, such room class information could be conveyed without requiring the user to scroll-over or click on a marker, such as by automatically displaying colored stripes on a marker fashioned to look like a hotel.

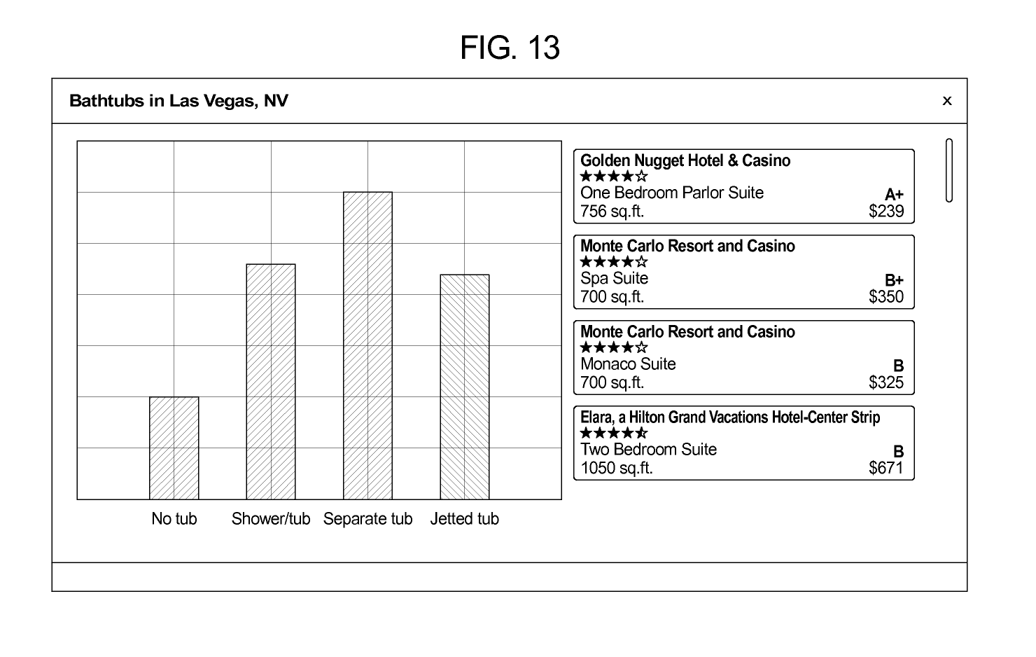

FIG. 13 is an example of a screenshot showing an amenity histogram. In FIG. 13, a histogram depicts the frequency of bathtub types in Las Vegas hotel rooms. When the user clicks on a bar in the histogram, the bar is illuminated, and room-classes containing that bathtub type are listed in the side panel from best deal grade to worst deal grade. In this embodiment, when the user closes the display box, the master list of results is filtered to include only those results that were part of the highlighted histogram buckets.

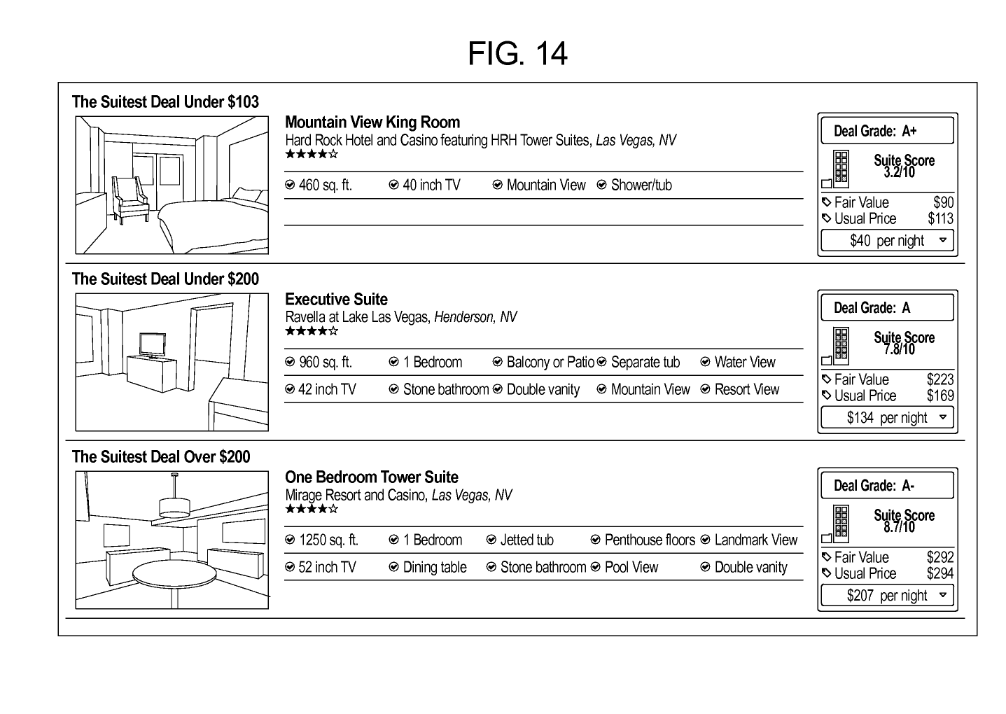

FIG. 14 is an example of a screenshot showing a stratified search result. In FIG. 14, the system has received many results (room-classes and associated prices) from an inventory source in response to a search request. The system has partitioned the market into three tiers: the cheapest one-third of rooms in the results set (those below $103 per night), the most expensive one-third of rooms in the results set (those above $200 per night), and the middle one-third (those between $103 and $200). The system has then identified and displayed the room in each market segment offering the best price in relation to its model value.

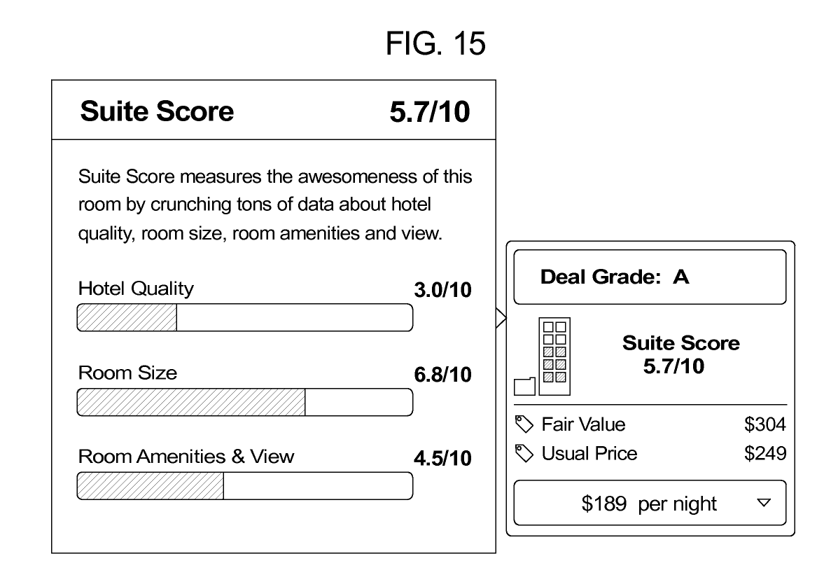

FIG. 15 is an example of a screenshot showing a Suite Score. In FIG. 15, a quality rating (“Suite Score”) has been assigned to a room, a hotel-tower icon graphically represents the numeric Suite Score, and a pop-over window provides further detail about the composition of the Suite Score. In this example, the Suite Score is composed of three elements: Hotel Quality, Room Size, and Room Amenities & View. For each of these elements, the system determined a score by ranking all of the rooms in a database according to that element and then assigning a score based on that ranking. For instance, with respect to room size, the room depicted in the figure fell in the 68th percentile of all rooms in the database ranked according to square footage; therefore, the room was assigned a score of 6.8 for the element Room Size. The Suite Score was then calculated as the weighted average of the three elements, with the weights being equal to the applicable factor scores determined in a recursive price analysis that included those three elements as factors.

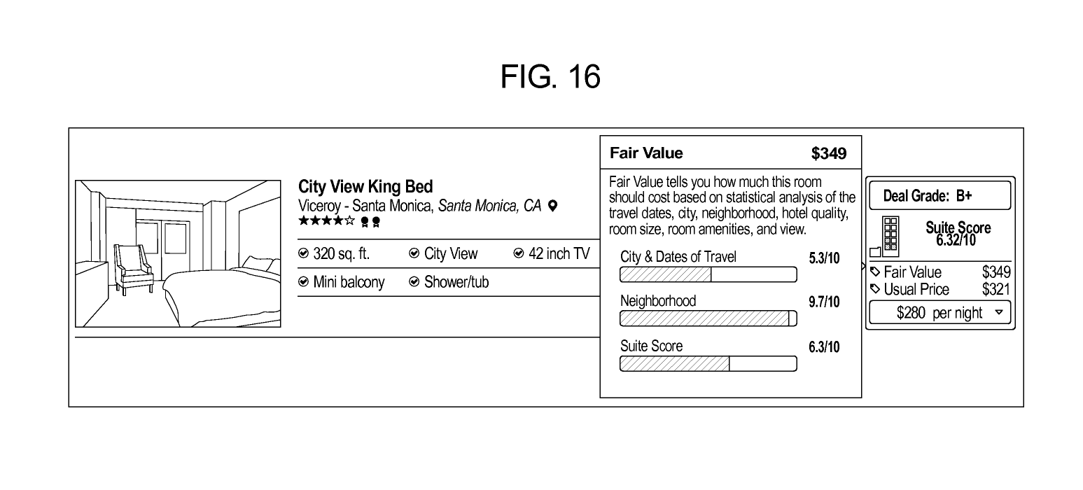

FIG. 16 is an example of a screenshot showing a Fair Value. In FIG. 16, the system has calculated a model value (“Fair Value”) for each room-class at each hotel in a given city on a given night. In this example, each model value was calculated by (i) first modeling an expected value for the latitude and longitude of each hotel location based on a distance weighted average of prices (“Neighborhood” value) without regard to the actual quality of the hotel under examination or its rooms; (ii) then modeling a change from that location-based expected value by assessing the difference between (w) the quality of the particular hotel & rooms (“Suite Score”) and (v) the quality of the hotel & rooms expected at that location based on a distance weighted averaging of surrounding hotels & rooms; and then modeling a change from that new expected value based on the difference between (x) average actual room prices within X miles of the location on the dates in question and (y) average room prices expected within X miles on those days of the week. For purposes of presentation to the user, however, the effect of the specific dates of travel is combined with the general price level in the search area and displayed as “City & Dates of Travel” score.

The systems and methods described herein may be embodied in systems including a controller and a memory coupled to the controller, wherein the memory is configured to store program instructions executable by the controller. The one or more controllers may be adapted to run a variety of application programs, access and store data, including accessing and storing data in the associated databases, and enable one or more interactions as described herein. Typically, the controller is implemented by one or more programmable data processing devices. The hardware elements, operating systems, and programming languages of such devices are conventional in nature, and it is presumed that those skilled in the art are adequately familiar therewith.

For example, the one or more controllers may be a PC based implementation of a central control processing system utilizing a central processing unit (CPU), memory and an interconnect bus. The CPU may contain a single microprocessor, or it may contain a plurality of microprocessors for configuring the CPU as a multi-processor system. The memory may include a main memory, such as a dynamic random access memory (DRAM) and cache, as well as a read only memory, such as a PROM, EPROM, FLASH-EPROM, or the like. The system may also include any form of volatile or non-volatile memory. In operation, the memory stores at least portions of instructions for execution by the CPU and data for processing in accord with the executed instructions.

The one or more controllers may also include one or more input/output interfaces for communications with one or more processing systems. Although not shown, one or more such interfaces may enable communications via a network, e.g., to enable sending and receiving instructions electronically. The communication links may be wired or wireless.

The one or more controllers may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller. For example, the one or more controllers may include a graphics subsystem to drive the output mechanism. The links of the peripherals to the system may be wired connections or use wireless communications.

Although summarized above as a PC-type implementation, those skilled in the art will recognize that the one or more controllers also encompasses systems such as host computers, servers, workstations, network terminals, and the like. Further one or more controllers may be embodied in a device, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller 12 can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the method may be provided based on various combinations of the features and functions from the subject matter provided herein.

I claim:

1. A computer implemented method of dynamically allocating costs of a rentable unit across two or more users comprising the steps of:
assigning two or more users to an event;
assigning a date range to the event;
assigning a rentable unit to the event, wherein the rentable unit includes a two or more assets and a total price for the assigned date range; and
receiving an initial bid for an asset from each user;
allocating a preliminary asset and a preliminary sub-total to one or more users based on the initial bids received, wherein the sum of the allocated preliminary sub-totals does not necessarily equal the total price of the rentable unit for the assigned date range; and
offsetting any difference between the sum of the allocated preliminary sub-totals and the total price of the rentable unit for the assigned date range by allocating a final sub-total to each of the two or more users, wherein the sum of the allocated final sub-totals equals the total price of the rentable unit for the assigned date range.

2. The method of claim 1 further comprising the step of:
each user executing payment of the user's allocated final sub-total through an online payment mechanism that consolidates the two or more user's executed payments into a single payment equivalent to the total price.

3. The method of claim 2 wherein the single payment equivalent to the total price is transferred to a party renting the rentable unit.

4. The method of claim 1 further including the step of dynamically adjusting either the preliminary sub-totals or the final sub-totals in response to receiving a second bid from a user.

5. The method of claim 1 wherein the initial bid for an asset from each user includes a joint bid associated with at least two users.

6. The method of claim 1 wherein preference to one or more assets is given to a joint bid from users that are designated as in a relationship.

7. The method of claim 1 wherein the rentable unit is one or more hotel rooms and the two or more assets are two or more heterogeneous sleeping areas within the one or more hotel rooms.

8. The method of claim 1 further including the step of storing and analyzing the final sub-totals in order to over time determine normal or fair price divisions for the rentable unit.

9. The method of claim 8 wherein the stored and analyzed final sub-totals are accessible to a user responsible for renting the rentable unit.

10. The method of claim 1 further including the step of providing a visual display of the allocation of the assets.

11. A computer implemented method of allocating costs of a rentable unit across two or more users comprising the steps of:
assigning two or more users to an event;
assigning a date range to the event;
assigning a rentable unit to the event, wherein the rentable unit includes two or more heterogeneous sleeping areas and a total price for the assigned date range;
assigning a sleeping area to each of the users; and
allocating a sub-total to each of the users based on relative value of the assigned heterogeneous sleeping area, wherein the sum of the allocated sub-totals equals the total price of the rentable unit for the assigned date range.

12. The method of claim 11 wherein the relative value of the heterogeneous sleeping areas is determined relative to the square footage associated with the heterogeneous sleeping areas.

13. The method of claim 11 wherein the relative value of the heterogeneous sleeping areas is determined relative to the amenities associated with the heterogeneous sleeping areas.

14. The method of claim 11 wherein the relative value of the heterogeneous sleeping areas is determined by an auction amongst the two or more users.

15. The method of claim 14 wherein the auction includes the steps of:
receiving a bid for one of the heterogeneous sleeping areas from each user;
allocating a preliminary sub-total to one or more users based on the bids received, wherein the sum of the allocated preliminary sub-totals does not necessarily equal the total price of the rentable unit for the assigned date range; and
offsetting any difference between the sum of the allocated preliminary sub-totals and the total price of the rentable unit for the assigned date range by allocating a final sub-total to each of the two or more users, wherein the sum of the allocated final sub-totals equals the total price of the rentable unit for the assigned date range.

16. The method of claim 16 wherein the step of allocating a sub-total to one or more users includes allocating a sub-total on a first to pay basis.

17. The method of claim 16 wherein the steps of assigning a sleeping area to each of the users and allocating a sub-total to each of the users based on relative value of the assigned heterogeneous sleeping area occur simultaneously.

18. The method of claim 16 wherein the step of assigning a sleeping area to each of the users is based on voting by the users.

19. A system comprising:
a controller;
a memory coupled to the controller, wherein the memory is configured to store program instructions executable by the controller;
wherein, in response to executing the program instructions, the controller is configured to:
assigning two or more users to an event;
assigning a date range to the event;
assigning a rentable unit to the event, wherein the rentable unit includes two or more heterogeneous sleeping areas and a total price for the assigned date range;
assigning a sleeping area to each of the users; and
allocating a sub-total to each of the users based on relative value of the assigned heterogeneous sleeping area, wherein the sum of the allocated sub-totals equals the total price of the rentable unit for the assigned date range.

20. The system of claim 19 wherein the relative value of the heterogeneous sleeping areas is determined by an auction amongst the two or more users, the auction including the steps of:
receiving a bid for one of the heterogeneous sleeping areas from each user;
allocating a preliminary sub-total to one or more users based on the bids received, wherein the sum of the allocated preliminary sub-totals does not necessarily equal the total price of the rentable unit for the assigned date range; and
offsetting the difference between the sum of the allocated preliminary sub-totals and the total price of the rentable unit for the assigned date range by allocating a final sub-total to each of the two or more users, wherein the sum of the allocated final sub-totals equals the total price of the rentable unit for the assigned date range.
